(19) United States
(12) Patent Application Publication
(10) Pub. No.: US 2005/0154627 A1
(43) Pub. Date: Jul. 14, 2005

(54) Transactional data collection, compression, and processing information management system

(76) Inventors: Bojan Zuzek, Califon, NJ (US); Richard John Knuckey, Bedminster (US); Alexander Fradkin, Fair Lawn, NJ (US)

Correspondence Address: Ward & Olivo, Suite 300, 382 Springfield Avenue, Summit, NJ, 07901, US

(21) Appl. No.: 10/749,940

(22) Filed: Dec. 31, 2003

(51) Int. Cl. G06F 7/00

(52) U.S. Cl. 705/10; 707/100; 705/3

(57) ABSTRACT

A system for gathering, formatting, validating, compressing, processing and storing a large volume of transactional data is presented. The system preferably analyzes pharmaceutical drug transactions. Importantly, the method of compressing the gathered data of the present invention detects repetitive behavior, and data patterns, to more efficiently process and store the large volume of transactional data. Also, the stored data is processed and analyzed more quickly due to its reduced size. Further, the present invention retains all useful information represented by the transactional data after compression of the data (i.e., it does not filter data for the purpose of reducing the quantity of data). The results of the process give users a truer sense of market activity. Additionally, the present invention allows new data to be added to historical data to allow a progressive analysis of the data.

### TECHNICAL FIELD OF THE INVENTION

The present invention relates to an information system capable of compressing, processing, organizing, analyzing, storing and displaying a large volume of longitudinal, raw transactional data. More particularly, the present invention performs operations on the initially gathered data using a sequence for evaluating and patterning data. Particularly, the system may be employed to analyze, store, and evaluate data commonly developed by large volume transactional systems such as transactional data related to pharmaceutical activities.

### BACKGROUND OF THE INVENTION

Various information systems are used in the art in transactional-type industries. For ease of reference, the system disclosed herein is described as it relates to the pharmaceutical and healthcare industry. However, the novel techniques, systems and principles described herein may be employed in various other transactional-type arenas.

Common pharmaceutical and healthcare systems known in the art are designed to allow physicians or pharmacists view patient medical histories to prevent potential drug interaction problems. Other similar systems are designed to automate healthcare processes. For example, systems are known in the art for determining an insured party's future healthcare costs. However, in general, the prior art systems fail to provide an information system that efficiently collects longitudinal prescription and OTC (over-the-counter) drug transactional data over an extended period of time and efficiently compress the raw data to facilitate storage, analysis, and processing of the data while incorporating some of the aforementioned technologies.

For example, Nichtberger U.S. Pat. No. 4,882,675 discloses a computerized system that allows customers to choose coupons from an electronic display, whereafter the electronic coupons are automatically applied to the customer's bill upon checkout. Customers are identified at checkout by presenting a card, designed specifically for use with the computerized system, which is scanned by the cashier.

Mohlenbrock et al. U.S. Pat. No. 5,018,067 discloses a system that gathers and analyzes treatment statistics, predicts treatment outcomes, and monitors actual treatment outcomes to evaluate the performance of health care providers.

Tawil U.S. Pat. No. 5,225,976 discloses an automated health benefit processing system. This system includes a database for storing treatment plans and medical procedures for the insured. Information relevant to the treatment plans or medical procedures is also stored in the database and appended to the associated plan or procedure database record. Tawil discloses a system that performs statistical evaluation of the diagnoses of the examining physicians.

Furthermore, Siegrist, Jr. et al. U.S. Pat. No. 5,652,842 discloses a system for analyzing patient treatment data, analyzing healthcare provider performance, and generating reports. This system compares the performance of multiple providers and the effectiveness of prescribed treatments.

Edelson et al. U.S. Pat. No. 5,737,539 discloses a system for creating prescriptions. The system accesses a remote database for drug formulary and patient history information and dynamically creates a transient virtual patient record to provide information that may be used to improve prescribing decisions.

Felthauser et al. U.S. Pat. No. 5,781,893 discloses a system for estimating prescription drug sales and distribution for multiple geographical areas. The system analyzes unsampled or poorly sampled data from multiple sources, including pharmacies and physicians' offices, to estimate retail sales in unsampled geographic areas based upon a spatial correlation analysis. The system uses multiple processors to process the large volume of transactional data.

McGauley et al. U.S. Pat. No. 5,899,998 discloses a system for maintaining and updating computerized medical records, wherein a distributed architecture database stores medical information at multiple point-of-service stations. Each patient must carry a “portable data carrier” containing the patient's complete medical history. Each point-of-service station is capable of reading the data in the portable data carriers, thereby eliminating the need for an online or live data connection to a central database or a master file.

Teagarden et al. U.S. Pat. Nos. 6,014,631 and 6,356,873 disclose a computerized system that physically interfaces with pharmacy computers and databases. The computerized system is used to select a set of patients that are eligible for prescription modification assistance, to evaluate each eligible patient's prescriptions, to facilitate the system user when consulting with a physician to review any recommended prescription modifications, and to communicate such prescription modifications to the patient.

Whiting-O'Keefe U.S. Pat. No. 6,061,657 discloses a method for estimating healthcare costs using linear regression techniques. Variable and coefficient of estimate models are built from historic patient data, which includes secondary and collateral illnesses that may affect the cost of treating a patient's primary illness.

Kraftson et al. U.S. Pat. No. 6,151,581 discloses a system for creating and administrating a patient health care management database. Specifically, each patient's clinical and satisfaction information is compiled to provide “practice-patient” data. The data is then analyzed to provide performance results for a group of physicians. The system also correlates selected portions of the performance results with the practice-patient data to provide practice measures.

Iliff U.S. Pat. No. 6,234,964 B1 discloses a system for long-term patient care that is intended to automate the patient care process. The system builds a longitudinal patient profile to provide objective analysis of the patient's response to various treatments. Thus, the system may analyze the data to provide suggestions for adjusting the patient's therapy. Also, the system may provide medical advice for symptom “flare-ups” and acute medical episodes.

Goetz et al. U.S. Pat. No. 6,421,650 B1 discloses a method for tracking the administration of prescription and OTC drugs. The system includes a database of drug recipients and each recipient's history of drug use. For the recipients' safety, the system monitors each recipient's current medications and doses and alerts the recipient of potential problems due to drug interactions.

Deaton et al. U.S. Pat. No. 6,424,949 B1 discloses a computerized system that maintains a database of customer transactional data based upon a customer identification code. The system automatically generates incentive coupons at the point-of-sale based upon the customer's shopping history.

Cortes et al. U.S. Pat. No. 6,480,844 B1 discloses a computerized system for predicting whether a telephone number represents a business or non-business entity by processing a large volume of collected call data. Specifically, Cortes discloses a system capable of performing “data mining” which involves relatively large data sets. These data sets represent millions of observations unlike other systems that only deal with thousands of observations.

### SUMMARY OF THE INVENTION

The present invention provides systems and methods for efficiently gathering, processing and storing a large volume of data over an extended period of time. Specifically, the transactional data is gathered, formatted, cleaned, compressed, processed, analyzed and stored in a database as part of a data transformation process utilizing various software algorithms.

In the preferred embodiment of the present invention, analysis of data is based on market study specifications. Particularly, the present invention is useful in the pharmaceutical arena to process data pertaining to prescription activities and OTC drug transactions. Specifically, data is gathered, formatted and validated and transformed into valuable intelligence related to pharmaceutical market activities. Market study views are collected from clients and contain data including, but not limited to, products/categories to be studied, dates and geographic areas. Market views are generally used by clients to, for example, prove or disprove market assumptions, discover unexpected trends and arrive at fact-based conclusions. Although the preferred embodiment of the present invention is designed for use with prescription and OTC drug transactions, it may be used to process any large volume of transactional information from sources that requires manipulation, analysis, or storage. This transactional information may be obtained from various sources including, but are not limited to, retail stores, financial markets, banks, research institutions, government bureaus, weather forecasters, etc.

The system of the preferred embodiment of the present invention includes a user-interface for administrators and clients to access the system. In the preferred embodiment of the present invention, the user-interface is displayed on a client Web portal or administration portal which includes any type of monitor that supports a web browser, including but not limited to a desktop personal computer, laptop, personal digital assistant, etc. Preferably, client users and administrative users log in to the system using a password or other like means utilized to access personal information such as biometric recognition. Clients access the system to create market views and collect finished reports. System administrators may access the system on a regular basis to check for pending report requests, publish completed reports, set system specifications, configure client options, add new clients to the system, confirm option settings, create test views, open and close user access, edit the client market log, create market definitions from client specifications (e.g., Therapy Area, Single Class, Custom Product definitions, etc.), set up report templates, create user profiles, manage the system, etc. In the preferred embodiment, the system's user interface includes a request/study monitor used to manage and monitor incoming report requests, a template editor, a group configuration editor, and a variety of study analysis views. Clients and administrators may communicate with the system through a Web server which allows fast and easy access.

Initially, the system of the present invention collects individual data files from multiple sources (i.e., various pharmacies, hospitals, physicians' offices, medical clinics, Internet distributors, etc.). Each data file contains the source's transactional data including an anonymous patient identification reference. In the preferred embodiment, the patient identification reference is an assigned number for keeping track of patient history at each facility. Information is kept anonymous and confidential in compliance with the Health Information Privacy Act. The transactional data is transferred via a communication network to the data warehouse facility. Significantly, the present invention allows information sources to keep existing network infrastructures to transfer data as the data is collected as diverse original format text files. The data must be formatted into standard format text files before processing. The system of the present invention performs several automatic operations which clean and validate the files for processing.

The system of the present invention includes a novel data transformation process. In the preferred embodiment, this data transformation process may be employed using NCR's Teradata database technology for data processing, or any other high performance database platform. This processing function is capable of greatly reducing the amount of prescription data. For example, in the preferred embodiment of the system of the present invention, data is compressed to ⅛ its original volume. To facilitate data parallel processing, data is physically distributed across the Teradata processing units. The system of the present invention is designed to enhance the performance of Teradata by utilizing a novel method to distribute data evenly across all processor units. Alternatively, any high performance database platform could be used for data processing. The aggregated transactional data undergoes the data transformation process which transforms prescription transactions into prescription “events.” The prescription events relate to studies based on a given product or market. Unique software algorithms execute the data transformation process which involves inserting raw prescription data into data storage tables, sorting and evaluating the data, performing calculations and efficiently consolidating information. The final results of the data transformation process are delivered as data interval tables which contain information on all products taken by all patients. The data transformation process dramatically reduces the amount of redundancy in the database, the storage space required, and the amount of time required to analyze the data.

In the preferred embodiment of the present invention, the data transformation process comprises six stages which transform raw prescription data into tables, determine time intervals, create product intervals, produce start indicators, identify open intervals, determine related intervals, and extract completed market studies. However, additional stages may be incorporated for detection of different events. A sequence of software algorithms, which in the preferred embodiment, run on Microsoft's SQL Server platform, perform the data transformation processes.

In the preferred embodiment, Stage 1 transforms raw prescription data into two database tables which store details on a specific transaction, including, but not limited to patient identification, dispensing entity, prescriber, dispensed NDC9 code, transaction identification, refill number, date, etc. “NDC” refers to the 11-digit format National Drug Code which identifies all pharmaceutical products marketed in the U.S. Stage 1 achieves a five times savings in data storage space.

Stage 2 performs steps which build a list of time intervals that show when each transaction occurred, repair missing refill transactions, calculate quantity per day prescribed to the patient, determine the titration level for the patient and store the results in a database table. A time interval represents an uninterrupted, single-product therapy regimen for a single patient. This stage in the data transformation process compresses data by storing information about prescription records rather than the individual records. Often, medication recipients repeatedly use the same medication with the same dosage over an extended time period. The algorithm compresses these records by creating one time interval. The prescription time interval transforms all details to all transactions and reduces the details down to the most useful essentials.

Stage 3 uses calculated time intervals to produce product intervals which contain all intervals relating to a given patient. This stage further reduces the amount of data by combining all time intervals with related NDC9s into a common product ID and merging the intervals together into one interval. However, the details behind a given product interval record can still be determined. The results of Stage 3 produce a list of products for each patient and the time intervals the patient was taking these products.

Stage 4 creates start indicators which show if an interval is the first use of a product, therapeutic category or market and identifies open intervals which are intervals that are either open on the left (past), right (future) or both. In Stage 4, every product interval is evaluated in relation to all other product intervals for the same patient.

In the preferred embodiment, there are four start indicators which may occur. For example, a “Category Start” is the first time the patient has taken any product in the therapeutic category.

Stage 5 evaluates each patient interval in relation to all other intervals for the same patient to see how the other intervals relate. In the preferred embodiment, there are three types of relations including Therapy Add-on, Co-Presribed Therapy, and Therapy Switch.

In the preferred embodiment of the present invention, New Therapy Starts relate to new activity for a product in the market and include two types of market definitions including Therapy Area and Single Class. Therapy Area market definitions are used to analyze concomitant switches, and other events, from one or more products to one or more products with any number of products and classes. Single Class Market definitions are used to analyze switches, and other events, from one product to another product in the same class. Importantly, the system of the present invention is valuable in that rather than looking at single Therapy Event Intervals in isolation, the system analyzes each interval in relation to the patient's other prescription transactions to identify those intervals of greatest interest to pharmaceutical marketers (i.e., product start events). Product start events give marketers useful insights into physician decision trends regarding their products as well as competitive products.

In Stage 6 of the preferred embodiment of the present invention, customized market studies according to end-user specifications are produced. Using a unique extraction algorithm, output files for customized market studies are created and stored in a database. In the preferred embodiment of the present invention, database tables are used to store this data.

The data transformation process of the present invention reduces raw data considerably. For example, the preferred embodiment of the present invention can achieve compression of over 600 gigabytes of raw data to 80 gigabytes of intelligible data, thereby facilitating data processing and reducing the memory required to store the data.

In addition to reducing the memory required to store the large volume of data, the present invention also reduces the time required to perform processing, such as statistical analysis, due to the smaller volume of data to be processed.

Importantly, the present invention does not rely on data filtration to reduce the quantity of data to be processed. Rather, the present invention retains all of the information represented by the original transactional data while reducing the amount of data to be processed and analyzed.

The system may periodically update its existing transactional records, thus appending new transactional data to the existing stored tables. The system provides two macros which keep time intervals refreshed with new transactional information and the system's integrated database updated. Thus, the system of the present invention has the most recent transactional data.

Moreover, the present invention is designed to progressively collect, compress, and store new data to allow for continuing analysis of the new data with the previously processed data. For example, new sources may be added with changing market studies. Data provided by a new source may be excluded until a sufficient history accumulates to retain the progressive nature of the existing data.

The system of the present invention further keeps its market data sources used as look-up tables updated. In the preferred embodiment, the system uses a Master Drug Database (MDDB) as a reference database to define custom areas and custom classes. This database is kept updated with the latest drug and custom market definitions. In the preferred embodiment, source look-up tables for Metropolitan Statistical Area data are loaded with the most recent available data as well. The system relies on these external databases as well as physician databases, geography databases, etc. as references. For example, the physician databases provide a variety of details on all registered physicians in the US market including address, medical specialties, etc. Notably, the system of the present invention assigns a unique physician identification number to each physician called a UMP. Unlike a traditional DEA identification number (the location specific system for identifying prescribers/physicians), the UMP ID remains with the physician regardless of his or her location of practice. The same physician is assigned only one UMP ID, thus maintaining a longitudinal link for cross-referencing physician's DEA numbers. The UMP ID provides a way to keep physician DEA numbers linked across time even if the physician relocates to an alternate location and is assigned a new DEA number. The system may further incorporate additional databases as source look-ups for additional markets.

The system of the present invention creates summarizations for each custom market in the database management system. Source look-up data, event files created in the data transformation process, and custom client market definitions are loaded into a database management system such as Oracle in the form of tables. In the preferred embodiment, an extraction, transformation and loading (ETL) engine creates summarized views from market study files. The tasks performed by the engine include loading data, initializing tables, summarizing data into tables, etc. In the preferred embodiment, summarized views are generated into application files which are delivered via a network server to the end-user or client's web browser. Further, this process is run to create new summarized views or update existing views when new data is available. Preferably, a back-up database is used to temporarily store market study files in case of delivery failure.

The Web environment of the preferred embodiment of the present invention further includes system applications for accessing a database and delivering results for a Web browser. In the preferred embodiment, a code engine application development tool, such as Macromedia's ColdFusion engine which interfaces with a Windows-based Web server, interprets codes, accesses the system database and delivers results as HTML pages for the Web browser. Further, a servlet runs in the Web server and provides server-side processing to access the system database.

The system of the present invention allows for a variety of different analysis views. Preferably, the user interface is designed to be interactive and reports are delivered to the user's Web browser as an applet. Reports are provided in the form of charts, tables, graphs, statistical results, share percentages, etc. as portable network graphic files.

The system of the present invention can be used for a variety of studies in the prescription drug and OTC arena because of the large volume of data that may be obtained. For example, the detection of patterns in the data may be determined and evaluated with outside influences in order to make proper projections. The invention may be used for such studies including, but not limited to, (1) analyzing patient behavior; (2) tracking or detecting fraudulent prescription use such as filling the same prescription at multiple sources; (3) detecting the prescribing behavior of physicians based upon multiple factors including place of education, employer, geographic area, average patient income, etc.; (4) grading the quality of a physician's care in relation to other physicians; (5) evaluating the results of prolonged individual drug use (i.e., users who take a specific drug for a prolonged period of time may consistently develop a secondary illness, adverse reaction, etc. that require a second prescription or OTC drug); (6) evaluating the results of prolonged use of specific drug combinations (i.e., users who take a specific combination of drugs for a prolonged period of time may consistently develop a secondary illness, adverse reaction, etc. that requires a second prescription or OTC drug); (7) evaluating the characteristics of introducing a new drug to the market including the rapidity with which physicians begin to prescribe the drug, rate of increase of prescribing the drug, etc. (8) evaluating the primary therapy areas for multiple-use drugs; (9) predicting the future drug use of an individual user; (10) predicting the future cost of treating an individual user having a primary illness; (11) re-evaluating FDA approval of a drug after the drug has been placed on the market for a predetermined period of time; (12) development of combination drugs (i.e., drugs that treat a primary illness and a secondary illness, effect, or nutritional need related to the primary illness with only one drug; (13) analyzing demographic drug usage; and (14) analyzing the prescription market.

If a nationwide system is instituted to track all prescription and OTC drug use on an individual, non-anonymous basis, the system of the present invention may incorporate features which include (1) detecting incorrectly prescribed drugs including incorrect type, incorrect dosage, incorrect instructions on how to take the drug, incorrect combination with another drug, etc.; (2) notifying individuals of prescription errors including automatic alarming at the source of the drug to alert the pharmacist that an incorrect prescription has been prescribed; (3) a computerized system for printing prescriptions that automatically notifies the prescriber that the prescription is in conflict with the patient's other existing or past prescriptions, the patient's allergies, the patient's physical ailments, drug recalls, etc.; (4) detection of unusually large quantities of a drug to the same user; (5) preemptively detecting harmful drug interactions; and (6) correlating a physician's prescription behavior with the physician's financial assets, etc. Importantly, the system allows for optimization of drug prescribing.

Specifically, the system could be beneficial for marketing prescriptions by assisting in the development of different medications since the system can follow the “cycle” of a drug. Drug forecasting could also be accomplished wherein the development of a new drug is determined based on drugs of a particular patient.

Furthermore, the system allows for the forecasting of patient needs based on the development of a patient profile and a particular patient's drug usage over time. The patient's ID and profile can be made anonymous by encryption and accessed similarly to a credit report profile. For example, the system allows doctors access to a patient's profile to allow for a more thorough diagnosis and treatment. In this scenario, it is preferable that confidentiality of a patient's profile is government regulated. This type of profile could be used to evaluate the safety of certain prescription products, to detect inappropriate use or inappropriate combinations of products, and to detect prolonged use of products that could lead to harmful side effects and/or addiction.

Furthermore, the prescribing behavior of doctors is another key issue. The system of the present invention would allow for tracking of historical prescribing behavior and doctor influences in relation to other doctors. This is useful for many reasons, including developing marketing strategies directed toward physicians.

Additional areas of use for the present invention other than the prescription drug and OTC arena include, for example, (1) trending customer purchase transactions, such as credit card transactions, to predict future consumer buying behavior for a class of consumers (i.e., shoppers shopping at Store A are likely to shop at Stores B, C, D) which may be used for targeted advertising among other things; (2) trending stock transactions to analyze the behavior of the stock market; (3) trending individual trader transactions to rate the performance of an individual trader versus other traders; (4) trending weather transactions to predict future weather patterns; (5) trending real estate transactions to predict future market appreciation/depreciation; and (6) trending astronomical transactions to analyze the characteristics of the universe. However, numerous other tracking systems may be developed based on the structure disclosed herein. However, other similar transactional-type data may be monitored and analyzed.

### SUMMARY OF THE DRAWINGS

A further understanding of the present invention can be obtained by reference to a preferred embodiment, along with some alternative embodiments, set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as of amended, but merely to clarify and exemplify the invention.

For a more complete understanding of the present invention, reference is now made to the following drawings in which:

FIG. 1 depicts an overview block diagram of the five system environments that comprise the software architecture of the preferred embodiment of the present invention and the processes that occur in each environment.

FIG. 2 depicts an overview block diagram of the communication protocol of the preferred embodiment of the present invention.

FIG. 2a depicts a flowchart illustrating the process for setting up a new system in the preferred embodiment of the present invention.

FIG. 3 depicts a flowchart illustrating the data formatting and data cleaning processes that occur with the data Extraction, Transformation and Loading (ETL) software tool of the preferred embodiment of the present invention.

FIG. 4 depicts an overview process map of the data transformation process of the preferred embodiment of the present invention.

FIG. 5 depicts an overview flowchart of the chronological stages of the data transformation process of the preferred embodiment of the present invention.

FIG. 5a depicts a detailed illustration of the major database tables used for data storage in the data transformation process of the preferred embodiment of the present invention.

FIG. 6 depicts a detailed diagram of Stage 1, “Create Rx_Master and Rx_Transaction Tables”, of the data transformation process of the preferred embodiment of the present invention.

FIG. 6a depicts an exemplary chart defining the variables contained in the Rx_Master and Rx_Transaction tables of the preferred embodiment of the present invention.

FIG. 7 depicts a detailed flowchart of Stage 2, “Create Time Intervals”, of the data transformation process of the preferred embodiment of the present invention.

FIG. 7a depicts a diagram illustrating the time interval creation process of the preferred embodiment of the present invention.

FIG. 7b depicts an exemplary diagram illustrating a “missing refill” in the preferred embodiment of the present invention.

FIG. 7c depicts an exemplary chart defining the variables contained in the Rx_Intervals table of the preferred embodiment of the present invention.

FIG. 7d depicts an exemplary chart illustrating the results of Stage 2 of the data transformation process of the preferred embodiment of the present invention.

FIG. 7e depicts a detailed flowchart of the macros used for Stage 2 of the data transformation process of the preferred embodiment of the present invention.

FIG. 8 depicts a detailed flowchart of Stage 3, “Create Product Intervals” of the data transformation process of the preferred embodiment of the present invention.

FIG. 8a depicts an exemplary chart defining the variables contained in the Product Intervals table of the preferred embodiment of the present invention.

FIG. 9 depicts a detailed flowchart of Stage 4, “Produce Start Indicators and Identify Open Intervals”, of the data transformation process of the preferred embodiment of the present invention.

FIG. 9a is an exemplary chart depicting five types of start_indicators, which include area start, category start, product start, restart, and intermittent.

FIG. 10 depicts a detailed flowchart of Stage 5, “Determine Related Intervals”, of the data transformation process of the preferred embodiment of the present invention.

FIG. 10a depicts a diagram illustrating a closer look at how related intervals are determined in the preferred embodiment of the present invention.

FIG. 10b depicts a diagram illustrating Single Class and Therapy Area market definitions of the preferred embodiment of the present invention.

FIGS. 10c-10d depict diagrams illustrating the New Therapy Start Category functions of the preferred embodiment of the present invention.

FIG. 11 depicts a detailed flowchart of Stage 6, “Extract Completed Market Studies”, of the data transformation process of the preferred embodiment of the present invention.

FIG. 12 depicts a detailed flowchart of the process for updating the Master Drug Database of the preferred embodiment of the present invention.

FIG. 13 depicts an exemplary Metropolitan Statistical Area source look-up table of the preferred embodiment of the present invention.

FIG. 14 depicts an exemplary “Client Market Log” in the preferred embodiment of the present invention.

FIG. 15 depicts a detailed flowchart of the Extraction, Transformation and Loading Summarization process of the preferred embodiment of the present invention.

FIG. 16 depicts a detailed flowchart of the steps for creating market definitions in the preferred embodiment of the present invention.

FIG. 17 depicts a detailed flowchart of the day-to-day system administration of the preferred embodiment of the present invention.

FIG. 18 depicts a detailed flowchart of the client/user perspective of the preferred embodiment of the present invention.

FIG. 19 depicts a detailed flowchart of the process for setting up report templates in the preferred embodiment of the present invention.

FIGS. 20a-20l depict exemplary analysis views of the system user interface of the preferred embodiment of the present invention.

FIG. 21 depicts an exemplary study request entered on a user's web portal for a study on antidepressants.

FIG. 22 depicts a result analysis for the exemplary antidepressant study specified in FIG. 21.

FIG. 23 depicts an alternate result analysis for the exemplary antidepressant study specified in FIG. 21.

FIG. 24 depicts another alternate result analysis for the exemplary antidepressant study specified in FIG. 21.

FIG. 25 depicts another alternate result analysis for the exemplary antidepressant study specified in FIG. 21.

### DETAILED DESCRIPTION OF THE PREFERRED EMBODIMENTS

As required, detailed illustrative embodiments of the present invention are disclosed herein. However, techniques, systems and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for purposes of disclosure and to provide a basis for the claims herein which define the scope of the present invention. The following presents a detailed description of a preferred embodiment (as well as some alternative embodiments) of the present invention.

Referring first to FIG. 1, depicted is an overview diagram of the system environments that comprise the software architecture of the preferred embodiment of the present invention. FIG. 1 depicts the five system environments and the processes that occur in each environment including the data transformation applications, scripts, queries, system engines, file, table and document applications.

In the preferred embodiment, data processing environment 102 (e.g., Teradata environment) is responsible for operation of the system's data transformation process of the present invention. Teradata's enterprise data warehouse is the preferred embodiment data processor because it offers a powerful platform with high-performance database technology. Teradata physically distributes data across its processing units for parallel processing. Alternatively, any high performance data processing platform may be used. Database environment 104 (e.g., Oracle database environment) provides data storage in the form of database tables and extracts summarizations for each client market. Web Environment 106 (e.g., Web Services-type architecture environment) delivers results to the end-user's Web browser and allows users to interface with the system. Back-up environment 110 (e.g., Geo-mapping environment) provides a server for temporary back-up storage of data.

Referring to FIG. 1, initially, raw pharmacy data 112 is collected from transactions that occur at raw data information sources located in various national locations. Alternatively, the system of the present invention may be used to collect and process data relating to international markets. In the preferred embodiment, raw transaction data is collected from a consortium of pharmacies. Data collected from the pharmacies may be in the form of prescription or over-the-counter (OTC) drug transactions and the data is stored as diverse original format text files. The data is transferred via a communication network to data extraction, transformation and loading (ETL) tool 114. The collection and transfer of raw pharmacy data is depicted and discussed in further detail with respect to FIG. 2.

Data ETL tool 114, formats the various data files for compatibility with the data warehouse in data processing environment 102. In this embodiment, the Teradata environment is used; however, the data may be formatted to operate with any data processor. Data ETL tool 114, cleans prescription data coming from various information sources and a set of files is generated. The processes that the data ETL tool performs are depicted and discussed in further detail with respect to FIG. 3.

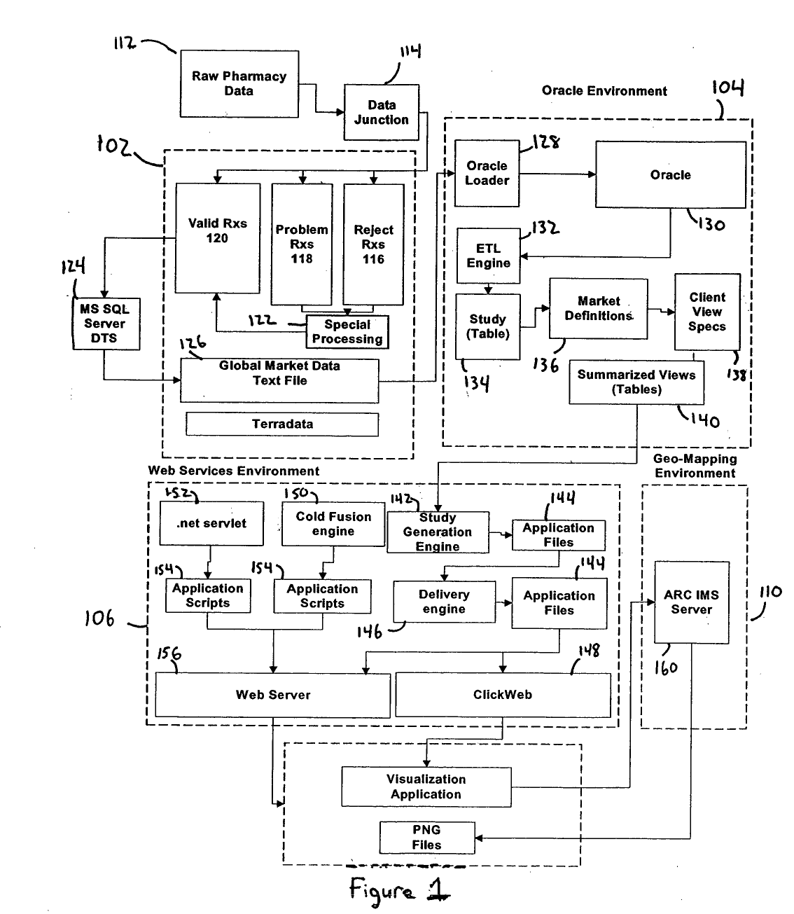

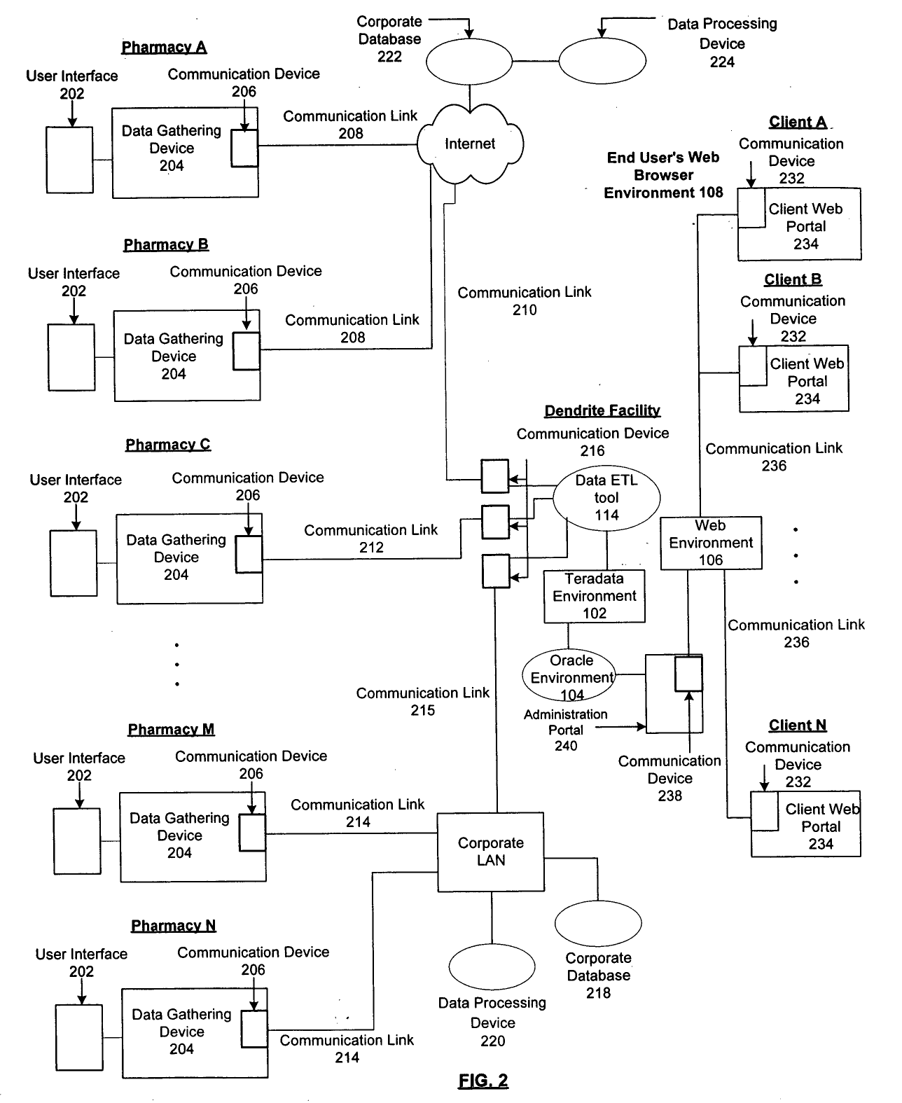

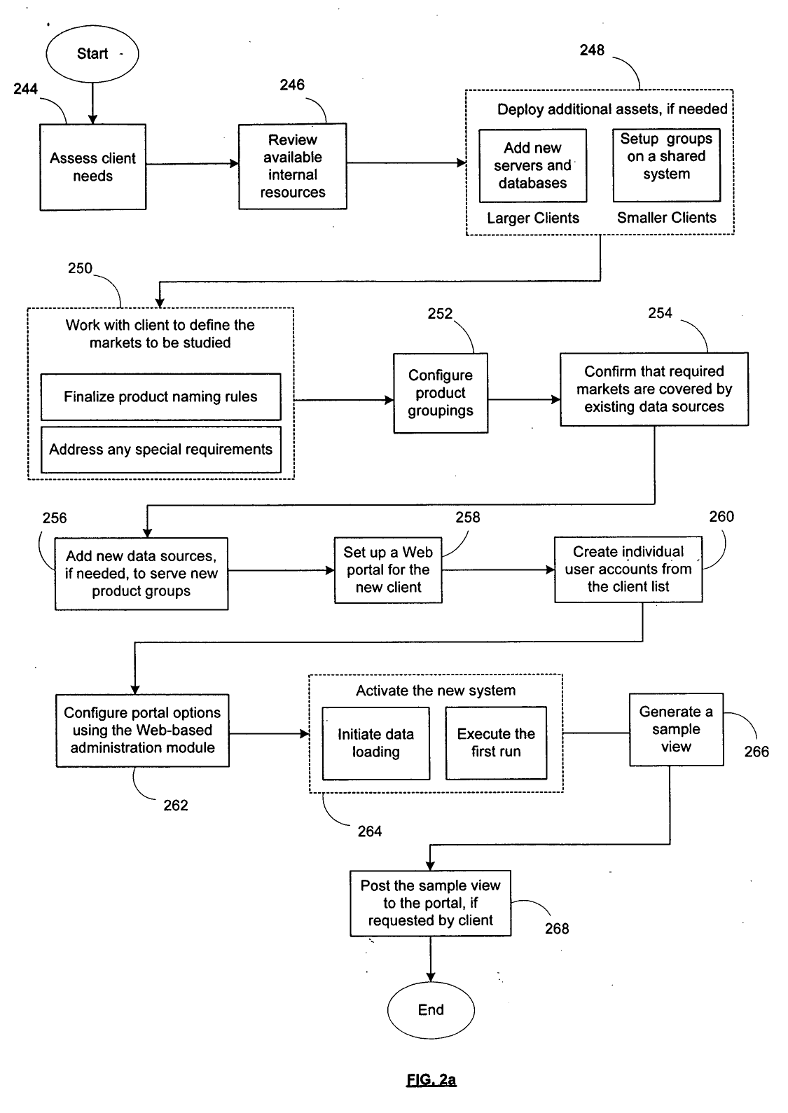

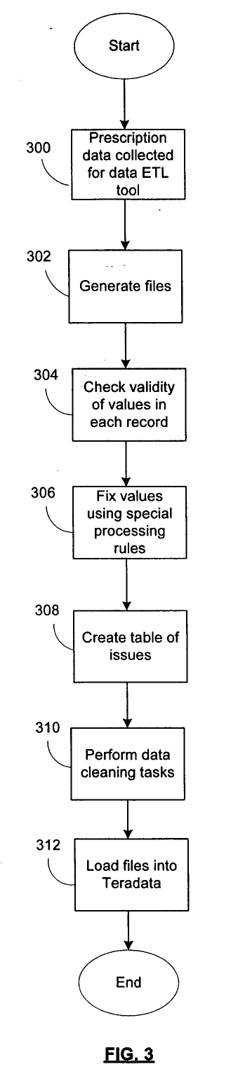

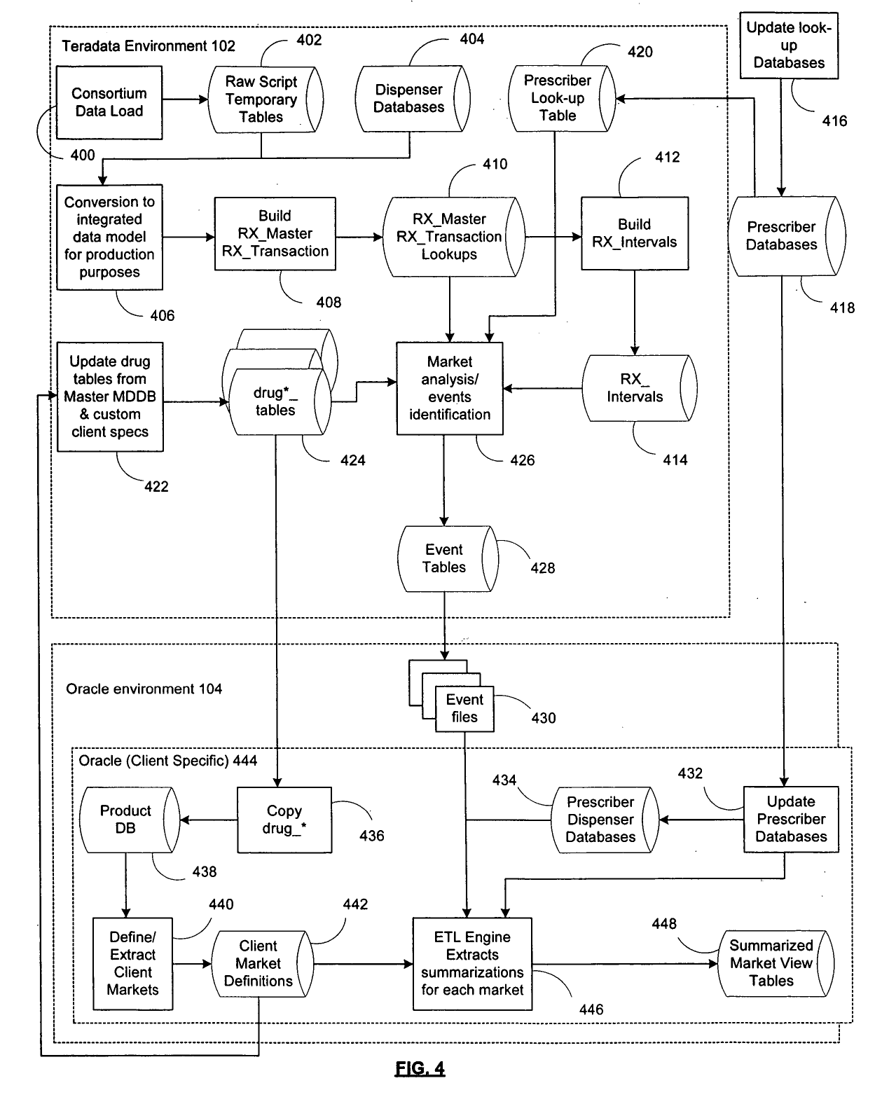

Continuing with FIG. 1, clean data is loaded into data processing environment 102. The files generated by data ETL tool 114 are grouped as standard format text files into three record types. Reject Rxs 116 and Problem Rxs 118 are transferred out of the system environment for “special processing” at 122. Special processing removes records that are supposed to be voided and updates records existing in the system. The cleaned prescription transaction data is then ready for prescription analysis and stored at Valid Rxs 120 as standard format text files. Since the prescription data files are entering the system in batches of different formats, the data must be transformed into a format that is compatible with the data processing environment before being loaded into the data processor. In the preferred embodiment, the data transformation process of the present invention is staged on Microsoft's SQL Database Management System (DBMS) Server 124. Alternatively, a similar intelligent DBMS server capable of data security, data integrity, interactive query, interactive data entry and updating could be used. The data transformation process of the present invention is depicted and discussed in further detail with respect to FIGS. 4-11.

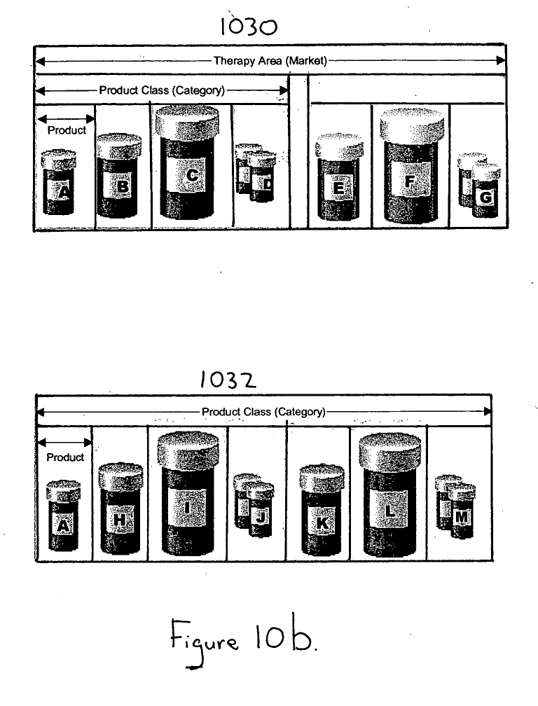

The data transformation process creates prescription events from prescription transaction data and in the preferred embodiment, compresses over 600 gigabytes of data down to 80 gigabytes, reducing prescription data to ⅛ of its original volume. Similarly, the system could be applied to compress the volume of any type of longitudinal data while retaining the data's properties. The system uses a core-integrated database that contains records on various markets used as look-up sources in the data transformation process. The output of the data transformation process is stored as text files and integrated with global market data file at 126 into the system's core integrated database. The process integrates raw transactional data with other data sources to create prescription events for custom markets. Other data sources relied upon include, but are not limited to, physician databases, prescriber databases, dispenser databases, geography databases, and drug reference databases. These external sources are integrated within the data processing environment and are kept updated by the system of the present invention. A description of the various data sources relied on as reference databases and the processes for updating the system's Master Drug Database is depicted and discussed in further detail with respect to FIG. 12.

In the system of the present invention, the results of event calculations in the data transformation process are output to flat files by an automated extraction process and are loaded into database management system 130. In the preferred embodiment, an Oracle database management system is used and the files are loaded via Oracle loader 128 for use in Oracle environment 104. In this database management system, extraction, transformation and loading of the data is performed to create summarized views. ETL engine 132 summarizes the data files obtained from the data processing system by extracting data stored in the various databases and creating study table 134 for each market study. The ETL Engine 132 updates the client market by obtaining data from various sources and converting the data for storage in study table 134 (e.g., Oracle study table). The ETL data summarization process that occurs in database management system 130 is depicted and discussed in further detail with respect to FIG. 15. Market definitions 136 are obtained from client view specification queries 136 to create updated custom market views based on client-user requirements. The data is summarized together with prescription event data output from the data transformation process, to create market views for specific clients. Market definitions are used to update the system's source look-up databases with the necessary data for each market. Summarized views 140 are stored in database management tables. The processes for creating market definitions from client specifications are depicted and discussed in further detail with respect to FIG. 16.

In the preferred embodiment of the present invention, summarized views 140 are converted to application files 142 by the system's study generation engine 142 in Web Services environment 106. Application files 144 are generated for each client market study. Application files allow for a variety of market analysis views and user interaction. A system administration portal with Web browser interfaces with the Web environment. Using the administration module, administrators can create and test application documents, set system specifications, perform day-to-day administration of studies, etc. This function is further depicted and discussed in greater detail with respect to FIG. 17.

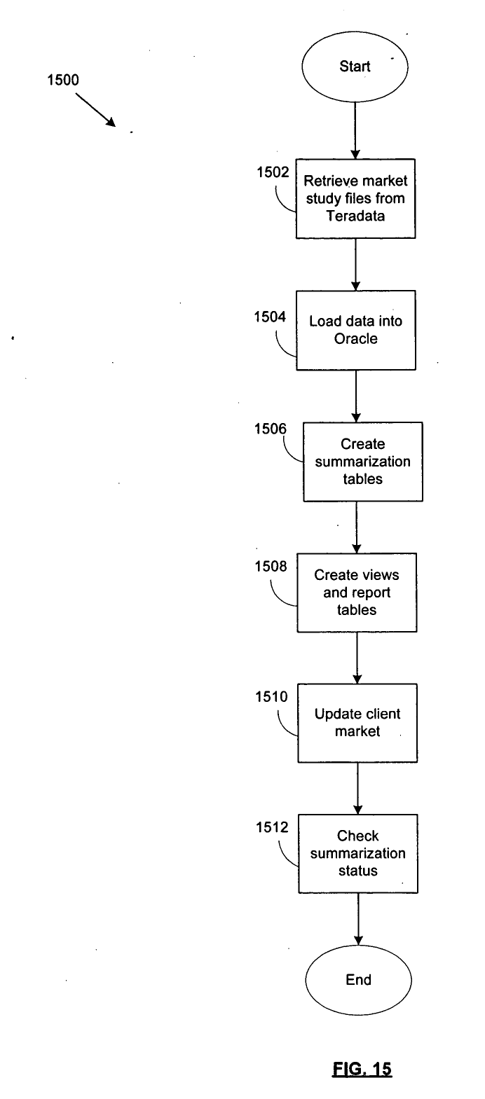

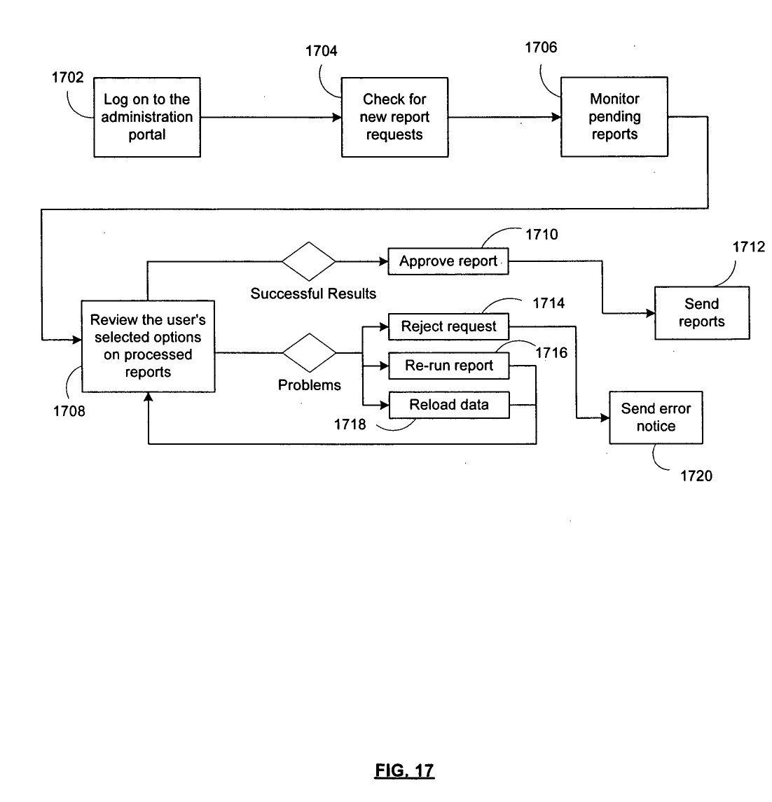

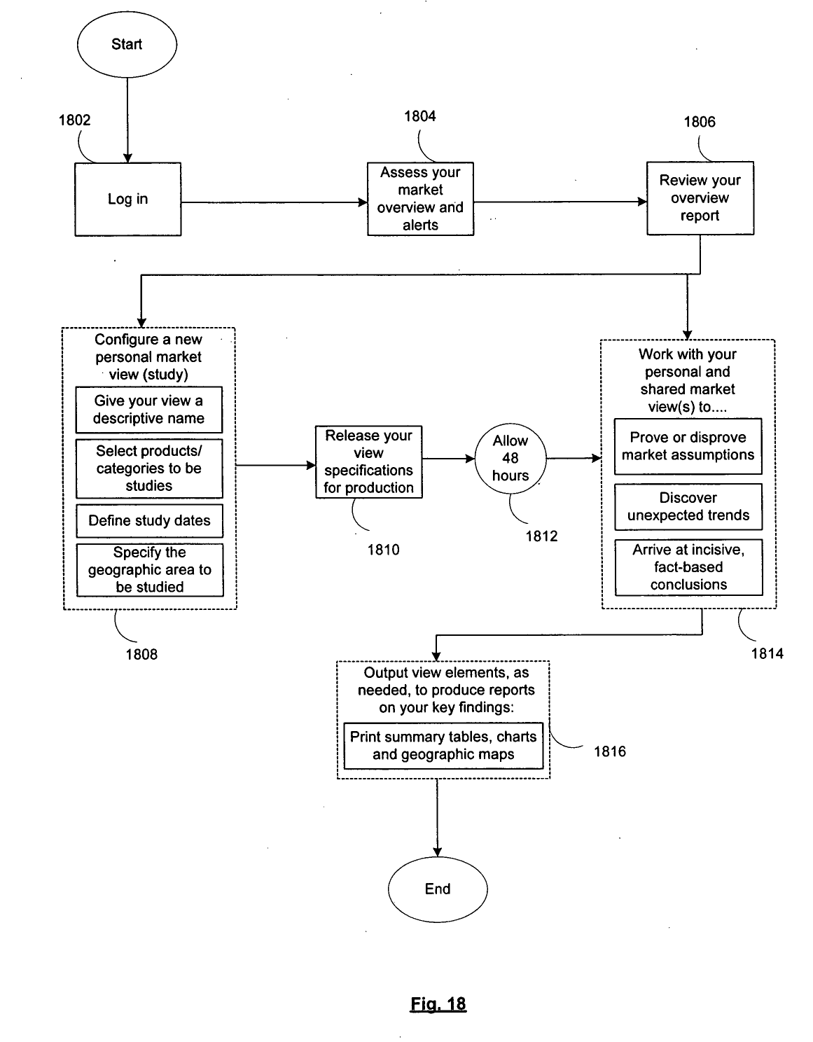

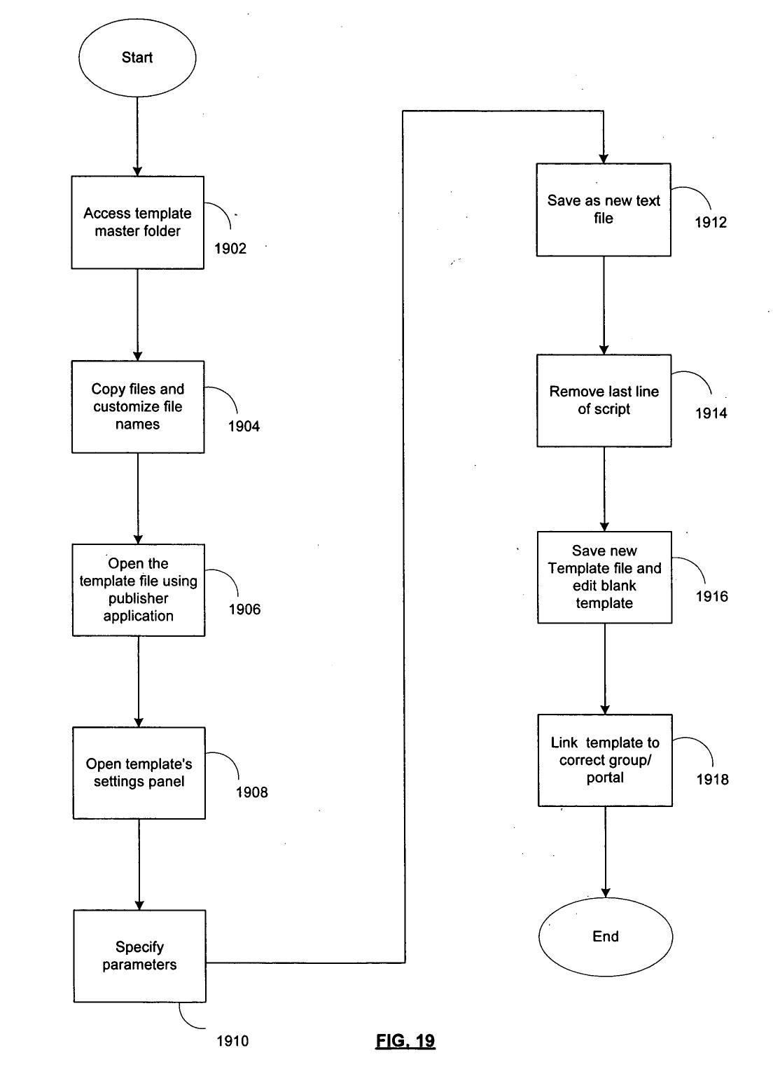

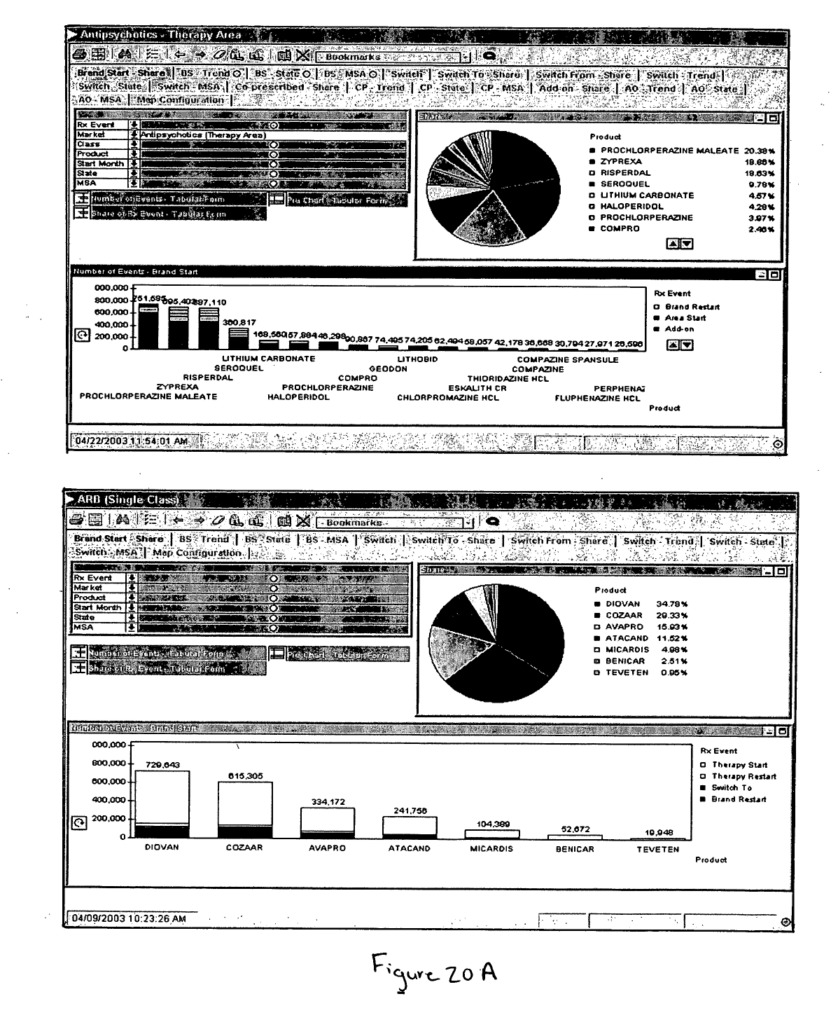

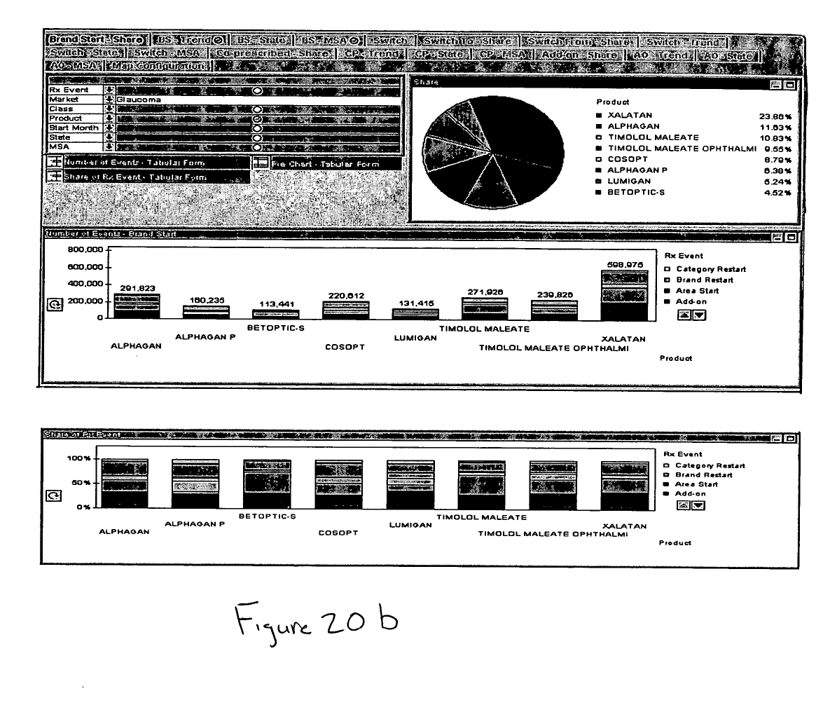

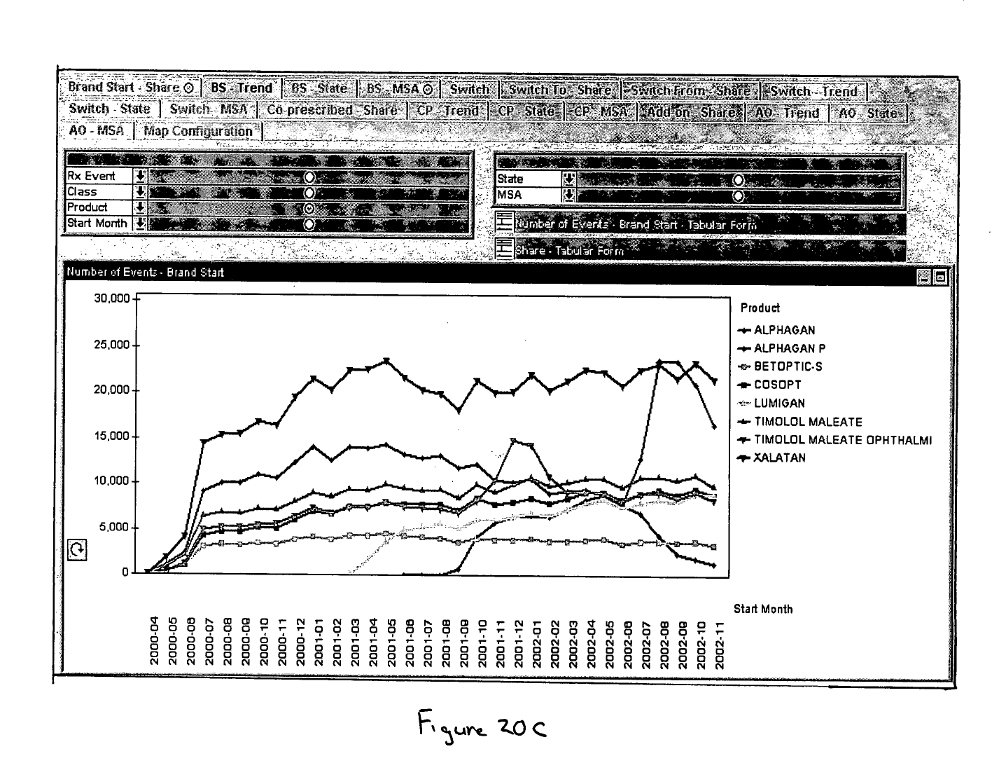

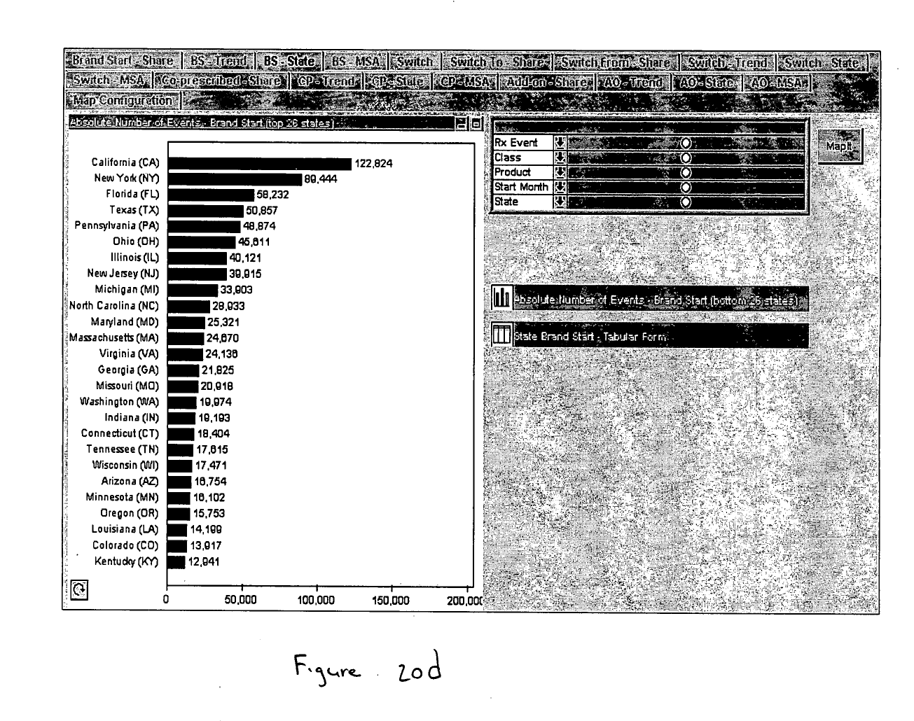

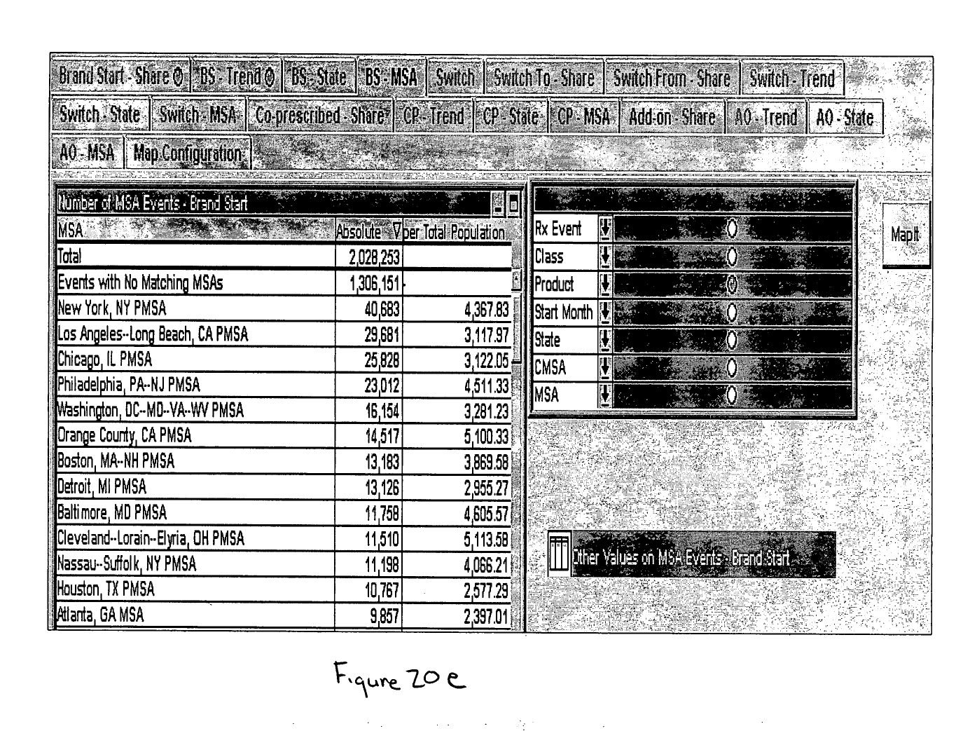

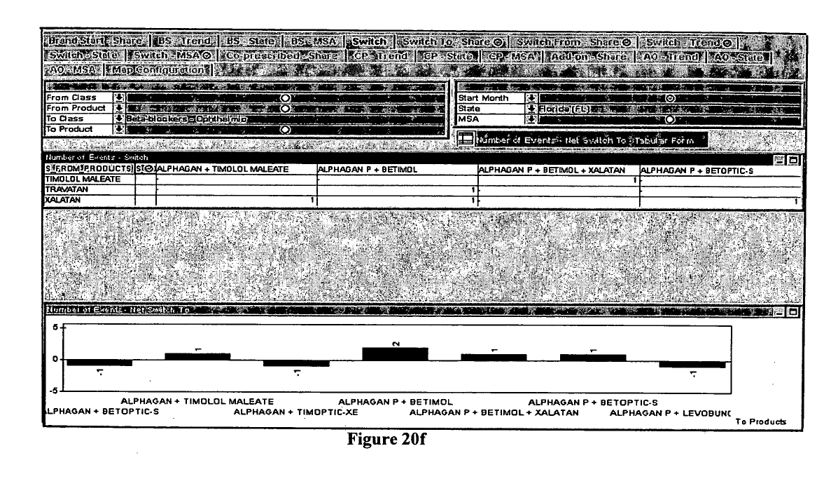

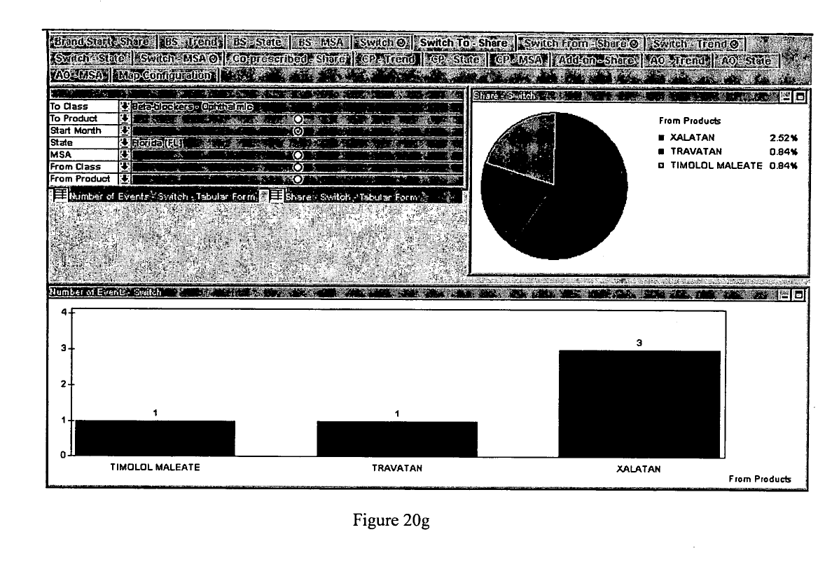

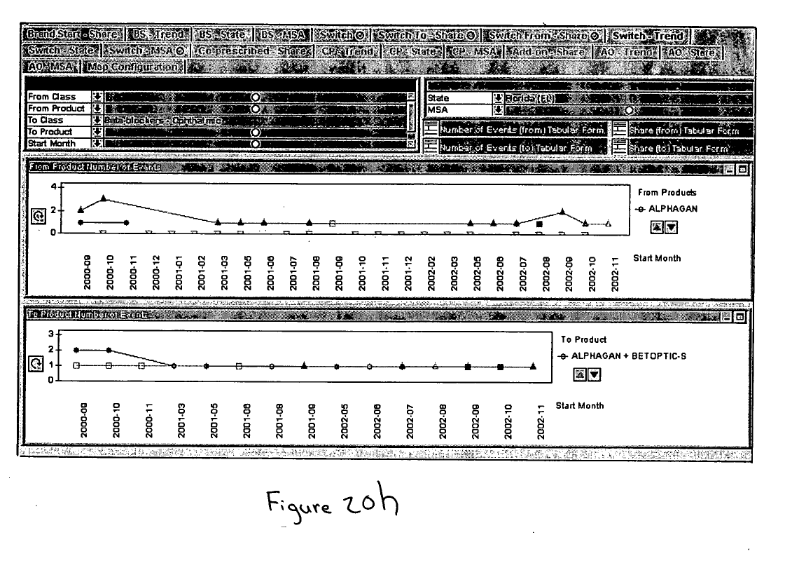

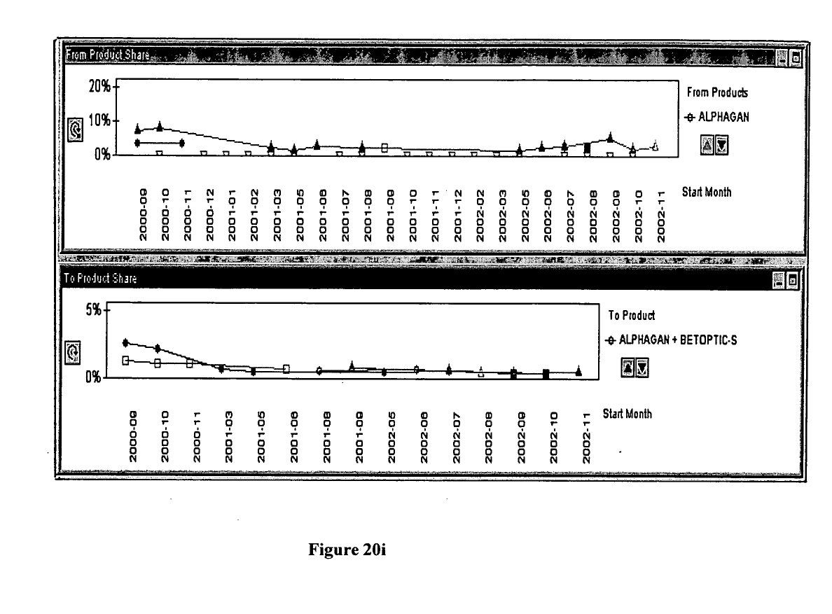

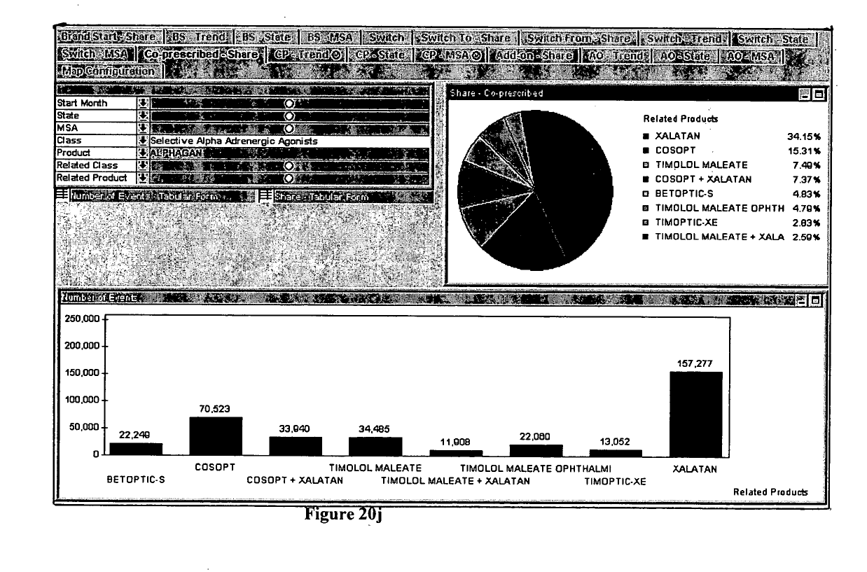

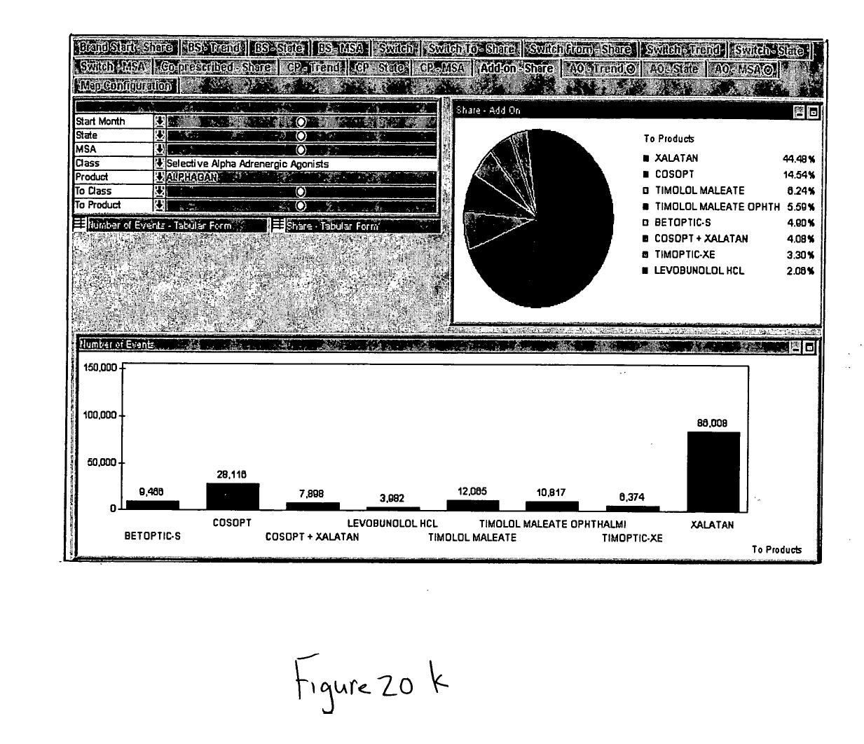

In the preferred embodiment, the system utilizes Microsoft's IIS 5 Web server 156 to deliver Web pages to the users' Web browsers. A servlet 152 (e.g., a “.net” servlet) running in the Web server and code engine 150 interfacing with the Web server are used to access and pull data from the system databases and deliver results as HTML pages to the Web browser. In the preferred embodiment of the present invention, Delivery engine 146 automatically transfers the new application files 144 to where they can be accessed by the system for review and approval by service administrators. An example of a common application file that may be used is a QlickView Application file. The application files are then made available to the appropriate end-user's web browser 108 via a web service provider 148 such as ClickWeb, and Web Server 156. The files reach the end-user's Web browser as visualization application 158. This application allows users to navigate to the various views by clicking on the applet's tabs in the user interface. Exemplary study analysis views provided by the system's user interface are depicted and discussed in further detail with respect to FIGS. 20a-20l. Study files are also sent to back-up environment 110 where copies of the data files are stored as backup on Archive Information Management System Server 160. Alternatively any database server dedicated to database storage and retrieval could be substituted. The client can view the files in end-user's Web browser 108 as portable network graphic (PNG) files 162 (alternatively, any type of image files such as gif, jpeg, etc., may be used), perform analysis on the results of the study, and output reports on the results. A flowchart showing use of the system to analyze markets from the user's perspective is depicted and discussed with respect to FIG. 18.

Referring next to FIG. 2, depicted is a block diagram of the network configuration utilized by the preferred embodiment of the present invention to gather raw transactional data from multiple information sources and transmit data to and from client sources. As illustrated, the information management system of the present invention is designed to collect anonymous transactional data from multiple pharmacies A-N, which may be located in different national locations. In an alternative embodiment, data may be gathered from other non-pharmacy facilities including, but not limited to, hospitals, physicians' offices, medical clinics, Internet distributors, etc. Also, in another alternative embodiment, the information management system of the present invention may be used to collect data from any non-pharmaceutical source that requires a large quantity of data transactions to be analyzed over an extended or ongoing period of time. These sources may include, but are not limited to, retail stores, financial markets, banks, research institutions, government bureaus, and weather forecasters.

When an individual transaction occurs at pharmacy A, the transactional information is entered into data gathering device 204 via user interface 202. User interface 202 may include a personal computer with a monitor, keyboard, and mouse, a standalone keyboard, monitor, and mouse combination, a bar code scanner, a credit card swiping device, etc. Data entered via user interface 202 is collected by data gathering device 204, which may be any type of data gathering unit including a central processing unit of a computer, a microprocessor, etc.

Initially, the transactional information that is gathered is associated with an individual patient. In the preferred embodiment of the present invention, data gathering device 204 makes the transactional information anonymous by assigning a unique ID number that is generated for each patient. Thus, the information management system of the present invention keeps track of transactions associated with an individual patient while allowing that patient to remain anonymous. Each individual that uses a particular pharmacy will have a unique ID number that is stored at the local pharmacy and every transaction made by that patient is associated with the same patient ID. If the pharmacy belongs to a national chain or corporation of pharmacies each patient's unique ID number will be stored in a central database. In this situation, individual patient data could be made anonymous by a corporate data processing device rather than at the local pharmacy.

The system of the present invention is designed so that when a patient changes doctors or sees multiple doctors, the patient is still tracked by the same patient ID. In the preferred embodiment, a patient will only retain his/her patient ID when switching pharmacy locations if the pharmacies belong to the same corporation or national chain. The system of the present invention may further be designed to track patients that switch corporations of pharmacies while still maintaining the patient's anonymity. This may be accomplished if a national healthcare identification system using electronic records is introduced. This application of the system of the present invention would be useful for detecting fraud.

The preferred embodiment of the present invention is designed to be compatible with multiple communication networks for collecting data from information sources including, but not limited to, the Internet, a token ring network, a wireless network, a LAN, a WAN, a virtual private network, etc. Each network transmits data packets over a communication link which is any medium capable of transmitting bi-directional digital communication signals including, but not limited to, a standard telephone line, a leased line, a PSTN, a wireless connection, etc.

At pharmacies A-N, data is transferred from data gathering device 204 through communication device 206 which is capable of bi-directional, digital communication via its associated communication link. Communication device 206 may be a modem, network interface card, wireless network card, RS-232 transceiver, RS-485 transceiver, etc., or any similar device capable of providing bi-directional digital communication signals.

In the preferred embodiment of the present invention, data collected at pharmacies A and B is transmitted from communication device 206 via communication link 208 to, for example, the Internet. Access to the Internet is provided via communication link 208 which may be any type of communication medium capable of transmitting and receiving digital communication signals over the Internet, such as Ethernet cable, DSL cable, telephone cable, etc. In this example, pharmacies M and N are both part of the same corporation. Data gathered from both pharmacies, as well as all pharmacies part of the corporation, and connected through the Internet, is stored into corporate database 222 and then made anonymous by data processing device 224 which includes a central server (i.e., a computer system in a network that is shared by multiple users). The anonymous transactional data is then stored back into corporate database 222. Alternatively, pharmacies part of different corporations could be connected through the Internet, in which case each corporation of pharmacies would have its own corporate database and data processing device with a central server.

The anonymous transactional data stored in corporate database 222 is then transferred via communication link 210, which may be any type of communication medium capable of transmitting and receiving digital communication signals over the Internet. Communication device 216 at primary facility receives the data transferred via communication link 210. In the preferred embodiment, communication device 216 may be any device capable of providing bi-directional digital communication signals over its associated communication link. Communication device 216 may be a modem, interface card, wireless network card, RS-232 transceiver, RS-485 transceiver, or any similar device capable of providing bi-directional digital communication signals.

Upon receipt of the transmitted transactional data at the primary facility, an acknowledgement may be sent from communication device 216 via communication links 210 and 208 and the Internet to communication device 206 to acknowledge receipt of the transactional data.

The information management system's compatibility with an Internet-based communication network has many advantages. The Internet facilitates data transfer to remote locations and provides a corporation of pharmacies, in disparate locations, connection to a central database. Data files can be updated and collected before being transferred to the primary facility of the present invention. Further, pharmacies can connect to the Internet using a variety of telecommunication technologies including, but not limited to, DSL, cable modem, telephone modem, Ethernet, etc. Also, many pharmacies already have an Internet communication network in place. These pharmacies can use the pre-existing connections to the Internet to transfer data to the remote site facility, without changing the network infrastructure.

Similarly, data collected at pharmacy C is transferred from communication device 206 via communication link 212, which may be any direct connection communication link including, but not limited to, a standard telephone line, a leased line, a cable line, etc. The data is received at communication device 216 at the remote site facility. In one example, communication devices 206 and 216 can be telephone modems and communication link 212 can be a standard telephone line. Alternatively, communication devices 206 and 216 can be cable modems and communication link 212 can be a cable line. These configurations result in faster and more secure and reliable communication. Since there is a direct connection between the two sites, there is no Internet traffic which could slow down the communication. Also, a direct connection communication link may be preferable when dealing with confidential information such as prescription and medical data which could be susceptible to unauthorized access in a less secure communication connection, such as the Internet.

In the preferred embodiment of the present invention, pharmacies M and N have an existing connection to a corporate LAN. Thus, all data collected at pharmacies M and N, as well as other pharmacies which are part of the corporate LAN, is transferred from communication device 206 via communication link 214 to corporate database 218 connected to the corporate LAN. Communication link 214 may be any type of coaxial cable used for connecting to a LAN including, but not limited to, CAT 5, coaxial cable, twisted pair, optical fiber, etc. Data collected at corporate database 218 is first processed by data processing device 220 which operates with a server to make the data anonymous. Aggregating the data from pharmacies that are part of the same corporation into one database allows for more efficient and accurate processing of data as well as easier transfer of data to the remote site facility. Also, individuals may use pharmacies that are in different locations but part of the same corporation. A corporate database allows the files to remain accurate and updated. After the data is stored in corporate database 218, it is transmitted via communication link 215. Since this type of configuration only requires one connection (i.e., from the corporate server to communication device 216), in the preferred embodiment, a leased line (i.e., a private communication channel leased from a common carrier) is utilized and the data is received by communication device 216 at the remote site facility. This type of network configuration is fast and secure. Confidential data cannot be accessed by any party outside of the corporate LAN. Further, a leased line provides guaranteed bandwidth a direct connection to the remote site facility, and maintains a single open circuit at all times.

At the remote site facility, all data gathered and received from pharmacies A-N by communication links 210, 212 and 215 is in the form of diverse original format text files. The data is aggregated and transformed with data ETL tool 114, where formatting and data cleaning occurs. Once the data is formatted, it enters data processing environment 102 which performs the data transformation processes and the data is then loaded into database management environment 104.

In the preferred embodiment of the present invention, data is collected from external sources and loaded directly into database management environment 104 as database tables. External database sources provide up to date market data including but not limited to physician data (i.e., details on all registered physicians in the US market including address, medical specialties, etc.) and demographic data.

In the preferred embodiment of the present invention, the system can be set for various sized clients in various locations. Larger clients require new servers and databases while smaller clients are set up on a shared system. A flowchart illustrating the process for setting up a new system for a client is depicted and discussed with respect to FIG. 2a.

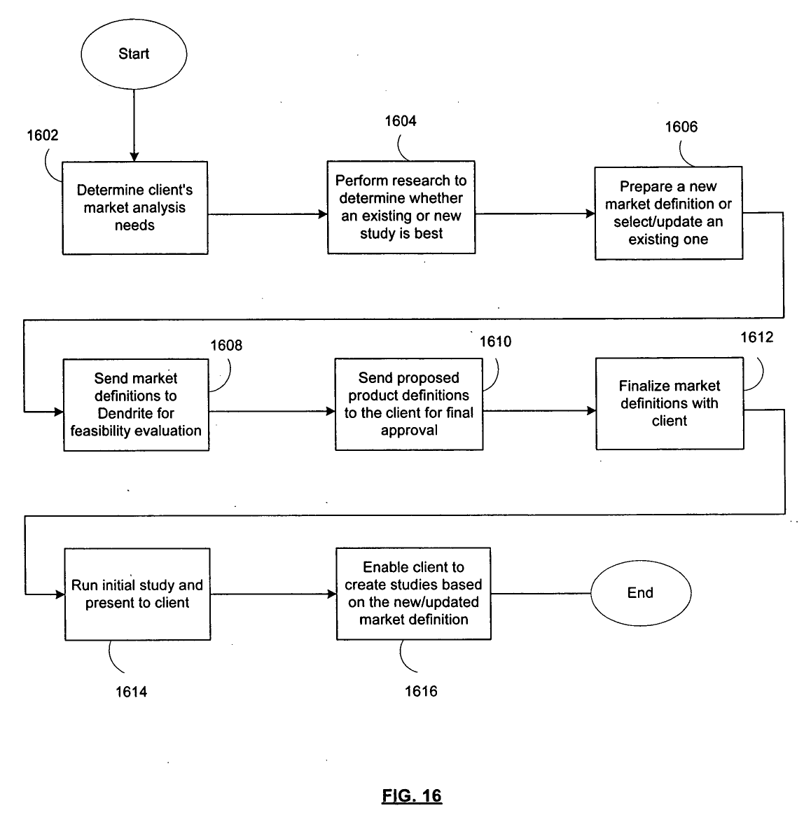

In FIG. 2, clients A-N interface with the system through client Web portal 234. The client Web portal may include a user interface with a monitor, computer, keyboard, mouse or any combination thereof. Clients access the system through a Web browser. Clients communicate with the system databases located at the system facility via communication device 232, which in the preferred embodiment of the present invention may be any device capable of bi-directional, digital communication via its associated communication link 236. Communication devices 232 may be a modem, network interface card, wireless network card, RS-232 transceiver, RS-485 transceiver, etc. Communication link 236 may be any communication medium capable of transmitting and receiving digital communication signals over the Internet, such as Ethernet cable, DSL cable, telephone cable, etc. In the preferred embodiment, client Web portal 234 communicates with Web environment 106 via the http communication protocol. Web environment 106 is used to deliver Web pages to the users' Web browsers. In the preferred embodiment, Web environment 106 utilizes Microsoft's IIS 5 Web Server. System administrators communicate and access the system via administration portal 240. Communication device 238 allows access to Web environment 106. SQL commands access and store the data from clients A-N in database management environment 104. Clients communicate market study specifications such as products/categories to be studied, study dates and geographic area. System Administrators access the data for each client and create market definitions based on client specifications. The data is stored in database management environment 104 along with completed reports for each market study. These reports are published to client Web portal 234 in End User's Web Browser environment 108 for client review via communication device 238, Web environment 106 and communication link 236. Reports are published in the form of application files created uniquely for each client using templates. The steps for setting up templates using a template editor are depicted and discussed with respect to FIG. 19.

Referring next to FIG. 2a, depicted is a flowchart illustrating the steps involved in setting up a new system for a client. First, at step 244, the client's needs are assessed. This includes goals, markets, categories, products of interest, etc. Next, internal resources are reviewed at step 246 to ensure that the needs of the client can be met. Then additional assets must be deployed at step 248. This involves adding new servers and databases for larger clients and adding smaller clients to a shared system. At step 250, System administrators work with clients to define the markets to be studied. This involves finalizing product naming rules and addressing any special requirements that the client may have such as a custom product definition. Next, product groupings must be configured at step 252. This step groups products into categories and areas of study. At step 254, it must be confirmed that the required markets are covered by existing data sources. New data sources may be added at step 256 to serve new product groups. New data sources may include but are not limited to information sources in different regions or demographic areas, specialized medical distributors, specific physician data, etc. Next, a Web portal is set up for the client at step 258 to allow the client to interact with the system. The system administrator creates individual user accounts from the client list at step 260. This is accomplished through the administration module which allows access to the system's Service Administration Web Site. Portal options are configured using the administration portal at step 262. This includes, but is not limited to, approval requirements for publishing completed reports, approval review period, location of the portal's publication folder, data time periods, purchased markets, study product list, report templates, Metropolitan Statistical Areas to be studied, purchase states, configuration of the Summarization and Delivery Engines, etc. The new system is activated at step 264 and a first run is executed. A sample view is generated at step 266 to test the results. The sample view is then published to the client portal at step 268 for client review.

Referring next to FIG. 3, shown is a detailed flowchart illustrating the functions performed by data ETL tool 114 in FIG. 1 of the preferred embodiment of the present invention.

Initially, raw prescription transaction data collected from various data vendors as diverse original format text files enters the system and is operated on by data ETL tool 114 at step 300. Data ETL tool 114 first generates a set of files at step 302 which in the preferred embodiment includes “good transaction records”, “reject records”, and “void records”. However, additional sets of files may be added as required. Good transaction records are records that will be loaded into the final integrated database. Reject records are records stored for statistical “housekeeping” purposes but not used in the integration process. Void records are used to determine which records are already in the system and need to be removed. Several other files are also generated that help control the data cleaning processes. After all files have been generated, the validity of values in each record is checked at step 304. Values are either fixed using special processing rules at step 306 or alternatively, a “table of issues” entry is created at step 308. The table of issues identifies transactions where one or more columns violate certain processing rules. Next, data is cleaned at step 310. This process involves correcting certain record columns, noting suspicious values in the table of issues for further investigation and identifying reject records. For example, records that lack a patient ID are rejected since the information that cannot be grouped with a patient ID is worthless for creating prescription events. The reject and void files are not permanently eliminated but are cleaned and worked on until the issue is resolved. The files are automatically processed and then integrated with the good records. After these initial conversions are complete, the clean data is loaded and stored into the data processing (e.g., Teradata) environment at step 312. The data is grouped and stored as standard format text files and is ready to enter the data transformation process.

With reference now to FIG. 4, a simplified process map of the entire data transformation process which occurs in data processing environment 102 (shown in FIG. 1) and the processes that occur in database management environment 104 of the present invention are shown. In the preferred embodiment of the present invention, data transformation processes are performed by Teradata and use Teradata's enterprise data warehouse as well as Oracle database management systems. Alternatively, any high-performance data processing platform may be used. For example, in the preferred embodiment, the data transformation process utilizes a unique algorithm that reduces over 600 gigabytes of raw data from 19 disparate aggregators, down to 80 gigabytes of intelligible data, reducing prescription data to ⅛ its original volume. FIG. 4 gives an overview of the data transformation processes of the present invention which occur in the data processing environment and the client specific processes that occur in the database management environment after the data calculations are complete. These processes are executed by various software algorithms.

Initially, in FIG. 4, consortium data is loaded at step 400 from various pharmacies and stored in raw script temporary tables 402. Raw pharmacy data is actual data from transactions that occur at the pharmacies. This data is combined with data from dispenser databases 404, which are the sources of the data (i.e., pharmacies), and converted to the system's integrated data model for production purposes at 406. The integrated data model represents how transactions are stored in the data processing (e.g., Teradata) environment. The Teradata data transformation process builds RX_Master and RX_Transaction data at 408 and stores them as RX_Master and RX_Transaction look-up tables 410. From these tables, compressed RX_Intervals are built at 412 and stored as RX_Intervals table 414. This reduces the amount of data while retaining the data's important properties for analysis. Rx_Intervals represent prescription events for a specific patient and product. Outside the data processing environment look-up databases are updated at 416 and stored as Prescriber Databases 418. From these databases, a prescriber look-up table 420 is created in data processing environment 102. Using client market definitions 442, created in database management (e.g., Oracle client specific) environment 444, drug tables in the Master Drug Database are updated at 422. The drug tables are stored 424 in the data processing environment and referenced during the data transformation process. From the aggregated data in drug tables 424, Prescriber look-up table 420, RX_Intervals table 414 and RX_Master and RX_Transaction look-up tables 410, market analysis and events identification occurs at 426. The results of this analysis are stored in event tables 428. In database management environment 104, event files 430 are created from event tables 428. Prescriber databases are loaded into database management (client specific) environment 444 and updated 432. Prescriber/dispenser databases 434 are stored in database management (client specific) environment 444. Drug tables 424 are copied at step 436 and stored in database management (client specific) environment 444 in product database 438. From these drug tables, client markets are defined and extracted at 440 by system administrators to create client market definitions 442. Client market definitions 442, event files 430 and prescriber/dispenser databases 434 are extracted to create summarizations for each market by the system's ETL data summarization process at 446. This process creates summarized market view tables 448 for each client.

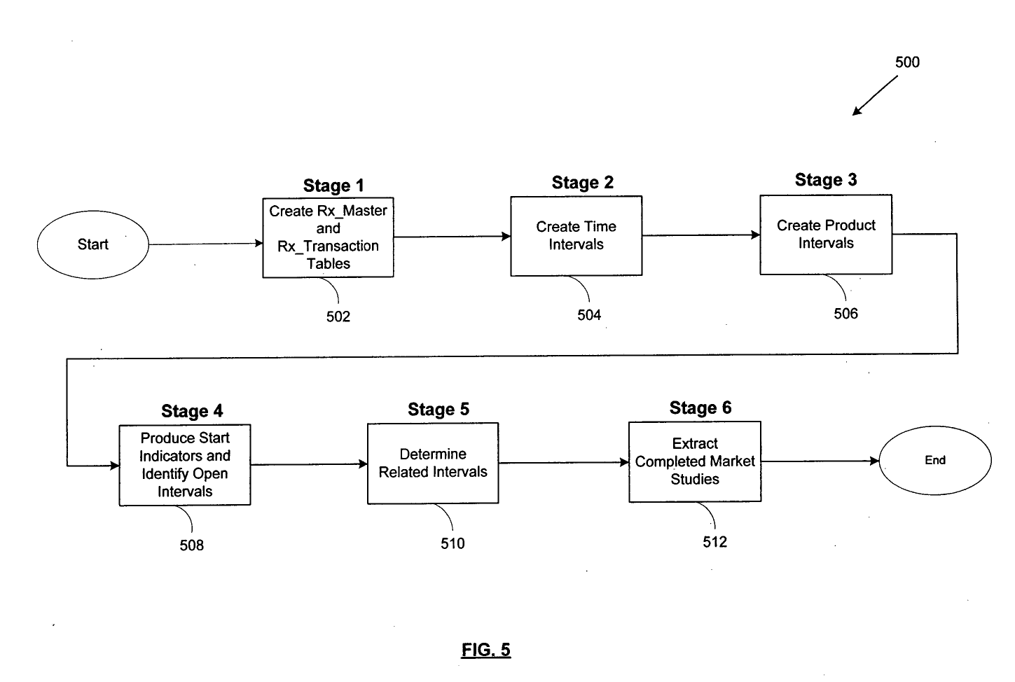

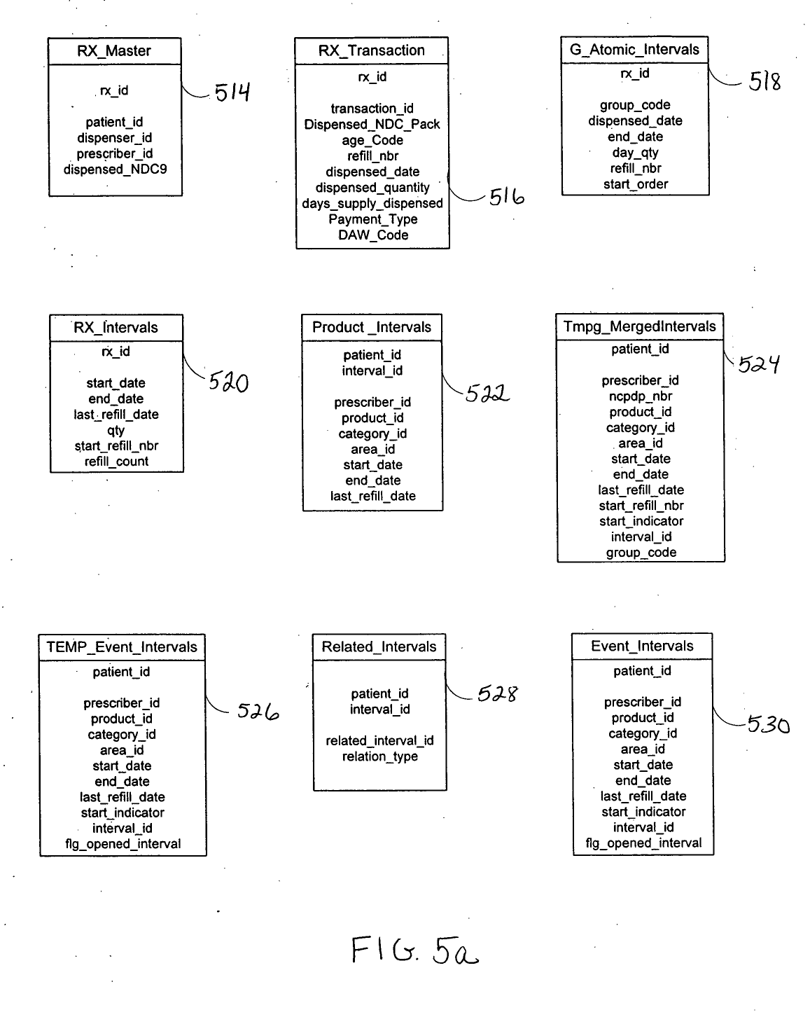

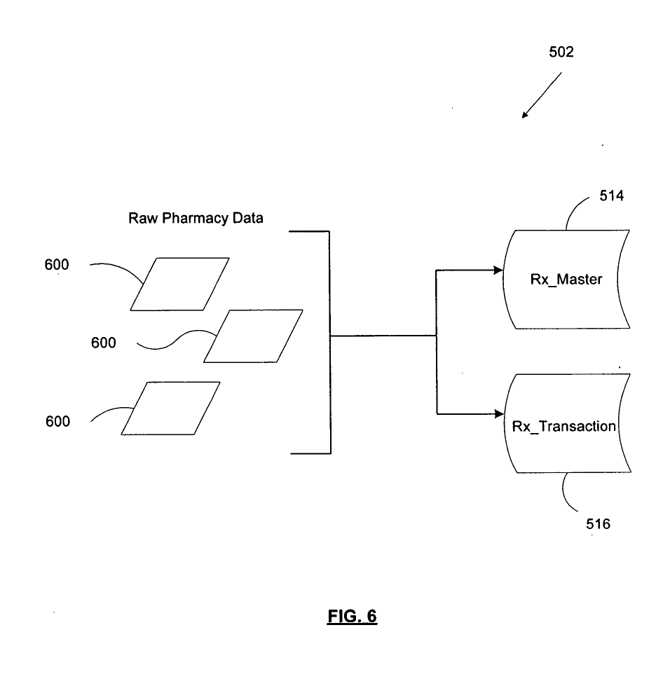

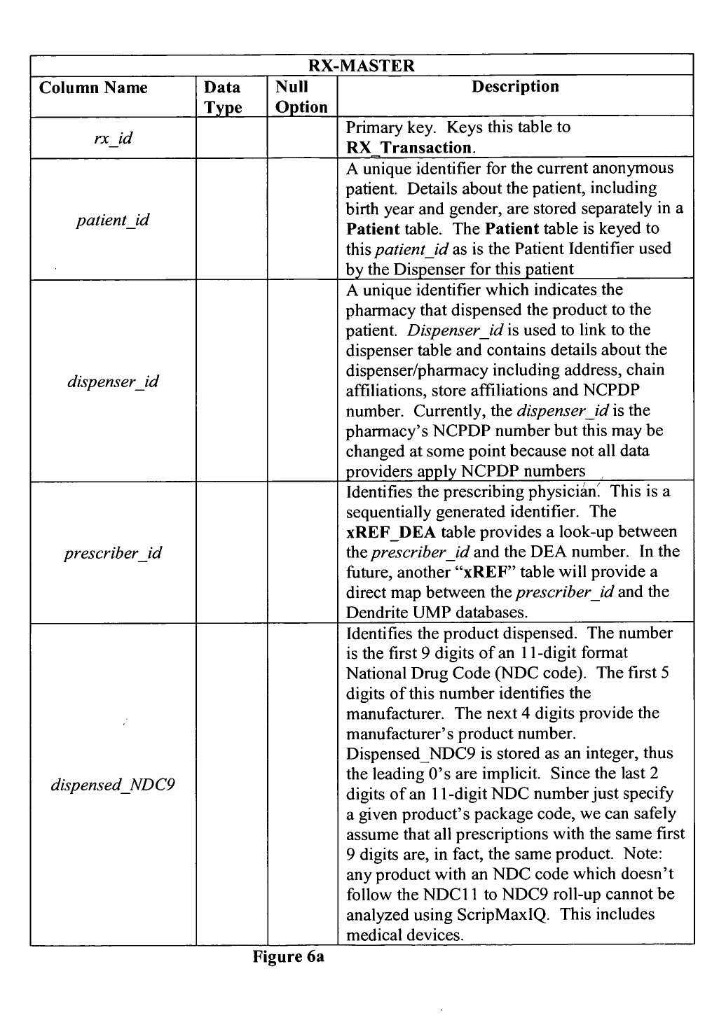

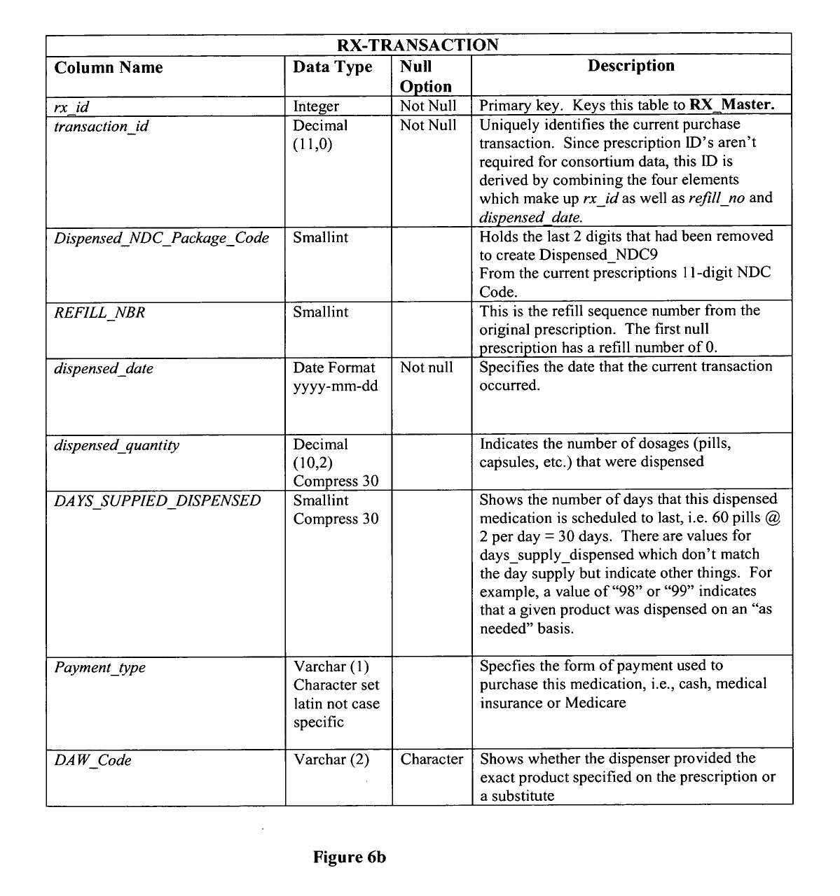

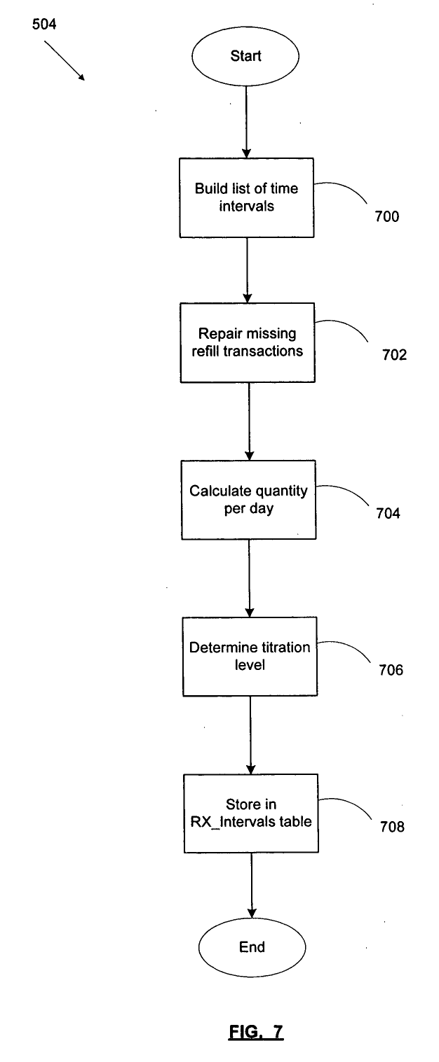

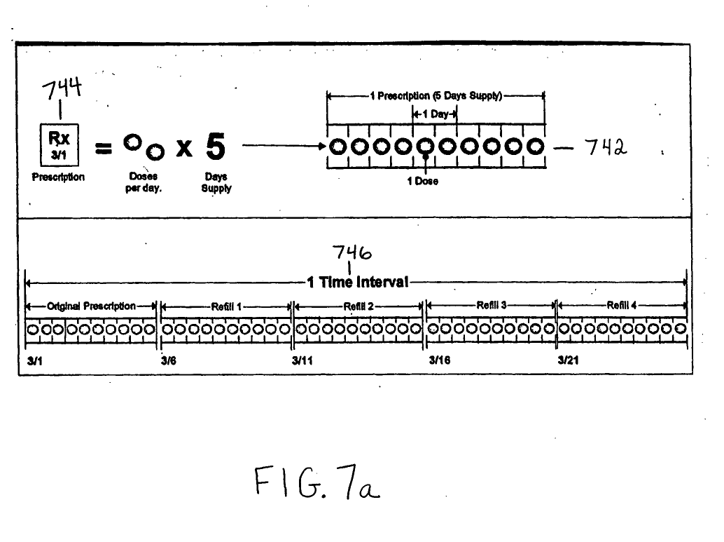

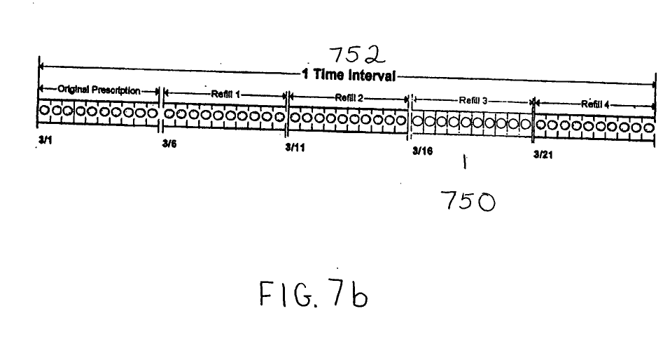

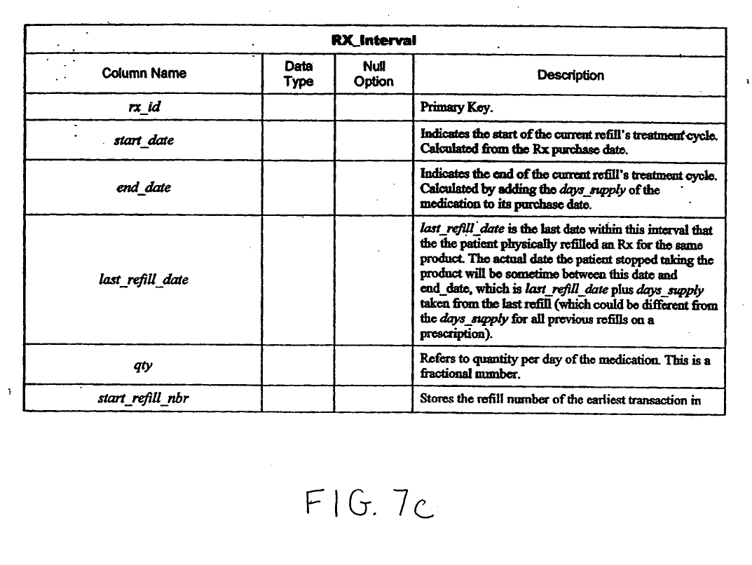

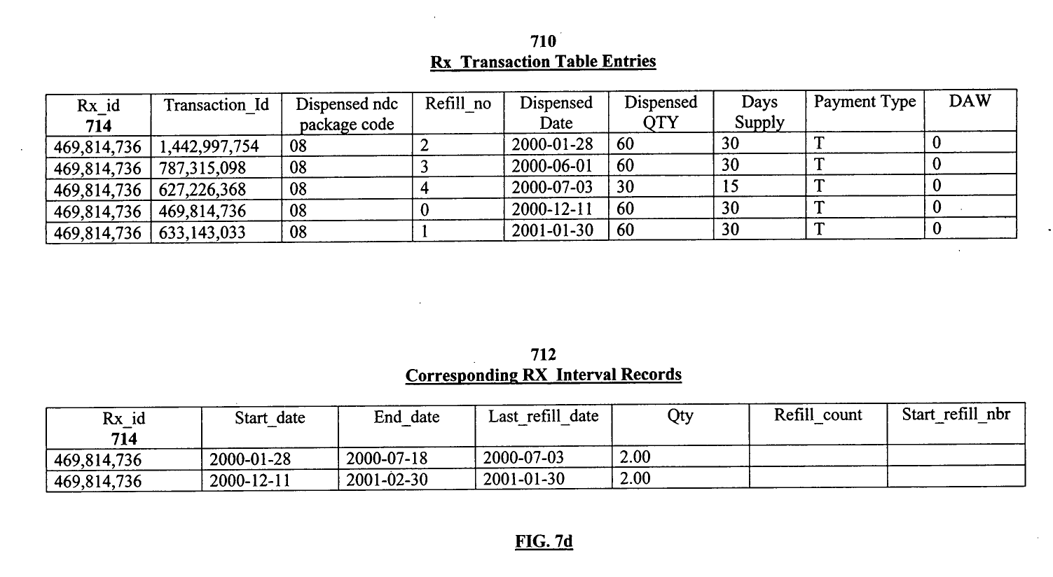

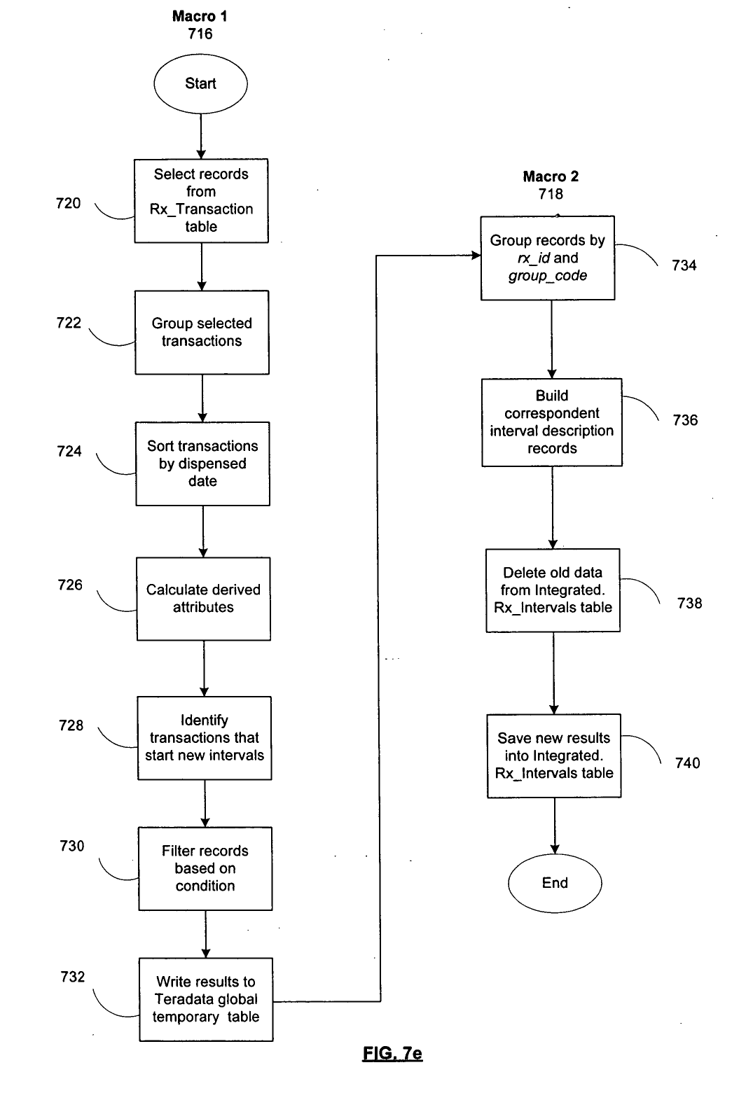

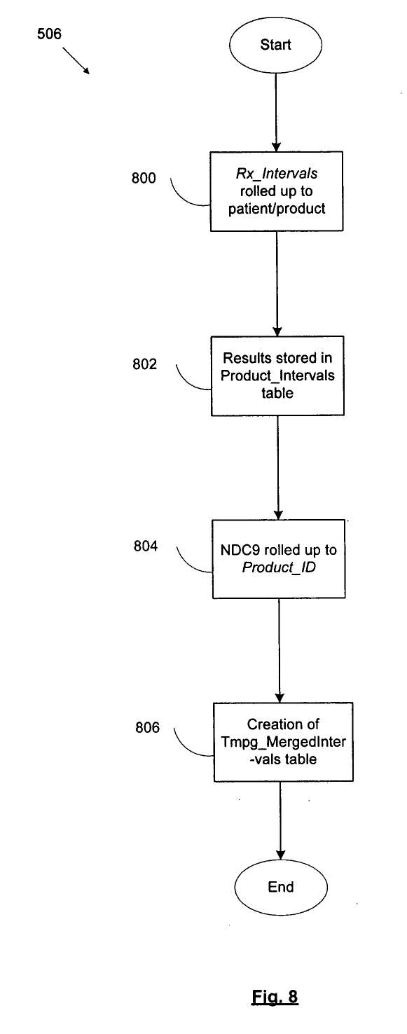

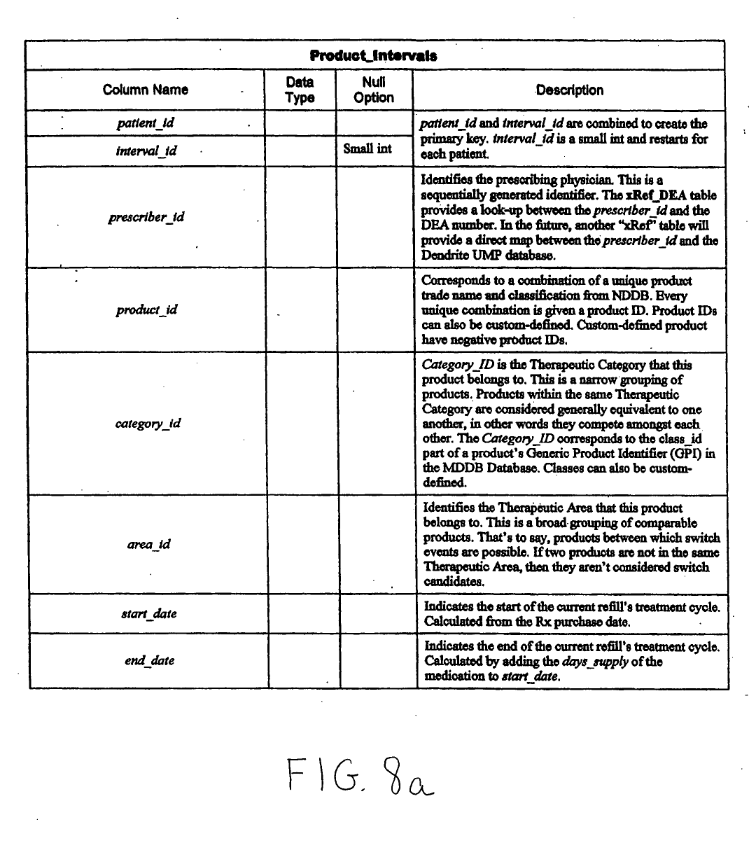

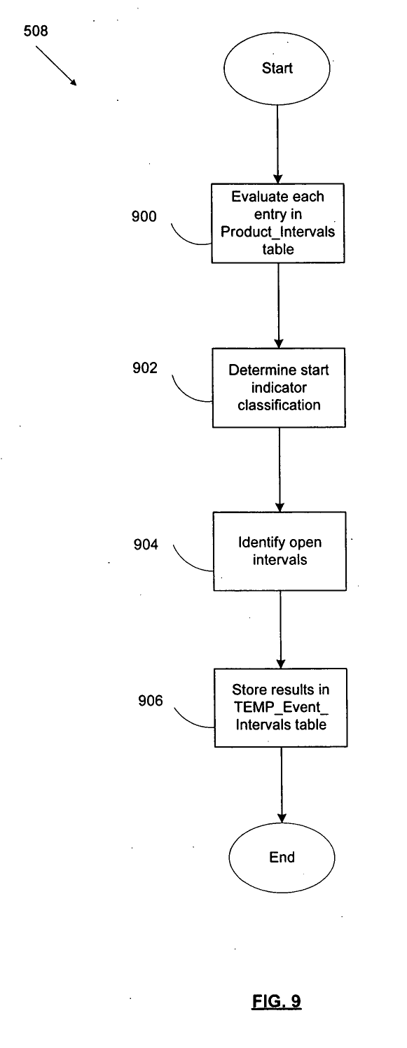

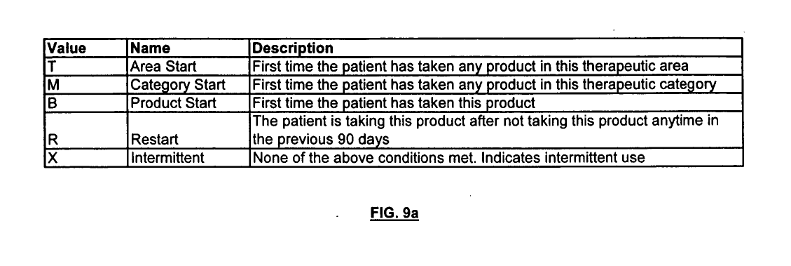

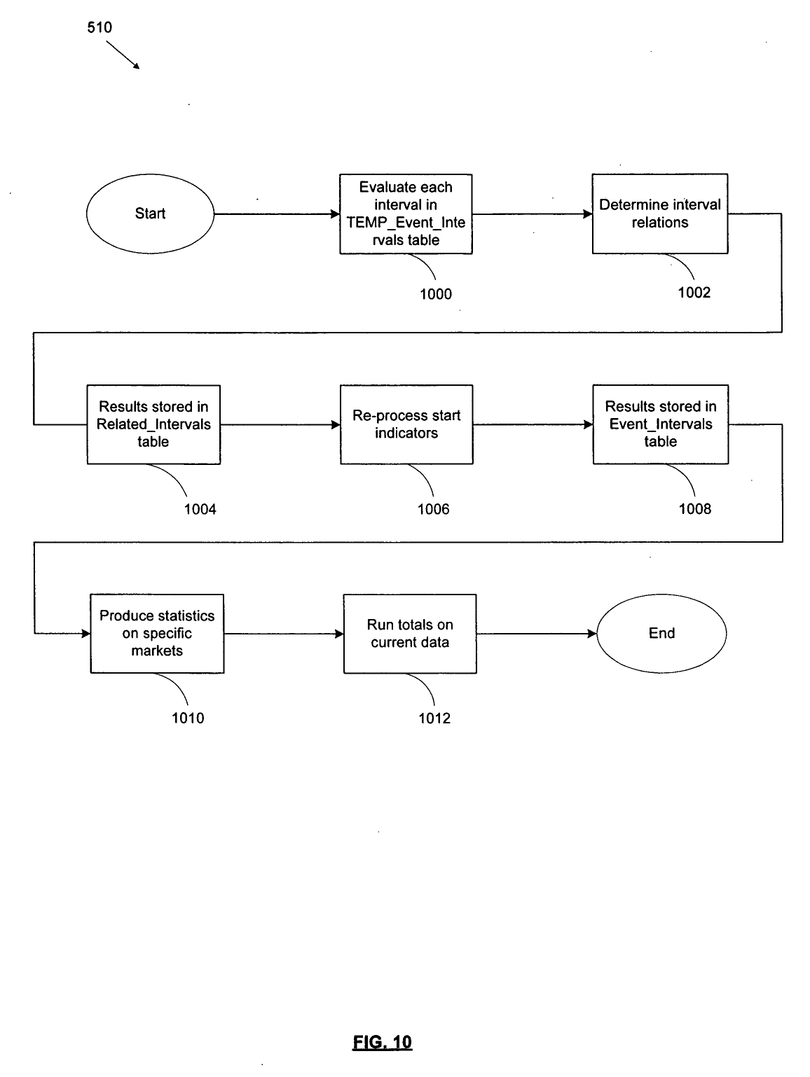

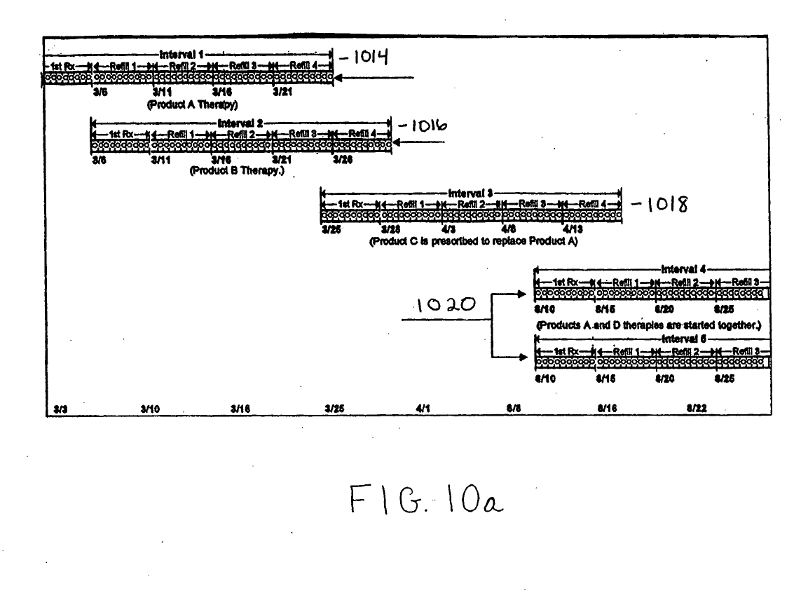

Referring now to FIG. 5, a flowchart is depicted, illustrating a chronological overview of the six stages of data transformation of the present invention that occur in the data processing warehouse. The data transformation process, as will be understood with reference to flowchart 500 uses algorithms to manipulate and analyze data creating a series of interval tables for more efficient storage and analysis of the data. The data transformation process begins with Stage 1, illustrated as step 502. In this stage, raw pharmacy data, collected from prescription transactions is transformed into two database tables. Stage 1 is depicted and discussed in greater detail with respect to FIGS. 6-6a. Next, Stage 2 of the data transformation process, illustrated as step 504, builds time intervals from the transaction records stored in the database tables created in Stage 1 and compresses the volume of data. A time interval represents an uninterrupted, single product therapy regimen for a single patient. Stage 2 identifies all prescriptions for a given product that were purchased by a given patient. This stage also includes steps that compensate for missing refill transactions and that calculate the dosage per day prescribed for a given patient. Stage 2 of the data transformation process is depicted and discussed in greater detail with respect to FIGS. 7-7f. Continuing with flowchart 500, Stage 3 of the data transformation process, illustrated as step 506, creates event intervals from the calculated time intervals of Stage 2. The creation of event intervals transforms data into the functional units of patient and product, and also merges related product intervals into one interval based on NDC9 values. Stage 3 of the data transformation process is depicted and discussed in greater detail with respect to FIGS. 8-8a. Stage 4 of the data transformation process, shown as step 508 of flowchart 500, produces start indicators which show if an interval is the first use of a product, therapeutic category or market, and identifies open intervals. In Stage 4, the product intervals of Stage 3 are evaluated in relation to all other intervals for the same patient to determine its start indicator classification. Stage 4 of the data transformation process is depicted and discussed in greater detail with respect to FIGS. 9-9a. Next, Stage 5 of the data transformation process, shown as step 510 of flowchart 500 determines the relationship between all patient intervals and re-processes start indicators. The results of this stage produce two final tables. Stage 5 is depicted and discussed in greater detail with respect to FIGS. 10-10c. Lastly, Stage 6 of the data transformation process, illustrated as step 512 of flowchart 500, produces customized market studies according to end-user specifications. Stage 6 is depicted and discussed in greater detail with respect to FIGS. 11-11a.

FIG. 5a shows the major database tables used in the data transformation process of the preferred embodiment of the present invention containing exemplary variables for each table. For example, a few of the major databases include Rx_Master, Rx_Transaction, Rx_Intervals, Event_Intervals, and Related_Intervals, and some of the exemplary variables include patient_id, prescriber_id, category_id, start_date and interval_id. Further tables and variables may be added as required for expanded analysis. These tables will be referenced with respect to each of the stages of the data transformation process detailed below.

Referring now to FIG. 6, depicted is a detailed diagram of Stage 1, illustrated as step 502 in flowchart 500, of the data transformation process of the present invention. As shown in FIG. 6, Stage 1 transforms prescription transactions that are collected from raw pharmacy data 600 into two tables. Raw pharmacy data 600 comes from prescription and OTC transactions occurring at information sources such as pharmacies (as shown in FIG. 2) and dispenser databases. The data is loaded into RX_Master table 514 and RX_Transaction table 516 (shown in detail in FIG. 5b). RX_Master table 514 contains, but is not limited to, the values for patient (patient_id), dispenser/pharmacy (dispenser_id), prescriber/doctor (prescriber_id) and product (dispensed_NDC9). NDC9 identifies the first 9 digits of an 11-digit format National Drug Code (NDC code). All prescriptions with the same first 9 digits are assumed to be the same product. RX_Transaction table 516 contains all secondary prescription details relating to transactions where the four values contained in RX_Master table 514 identify the same patient, dispenser/pharmacy, prescriber/doctor and product. RX_Transaction table 516 contains the values for purchase transaction (transaction_id), the last two NDC code digits (Dispensed_NDC_Package_Code), refill sequence number (refill_nbr), transaction date (dispensed_date), dosage number (dispensed_quantity), days supply (days_supply_dispensed), payment type (Payment_Type), and if the product was substituted (DAW_Code). The two tables are linked by the rx_id variable. If more than one product prescription is written for a single patient, they will all appear together with a single rx_id. The charts depicted in FIG. 6a provide definitions of common exemplary variables contained in RX_Master table 514 and RX_Transaction table 516, however, to further tailor an analysis, additional variables may be utilized. By splitting transactions into two tables, the system is able to achieve a five times savings in data storage space. Further, when a new transaction is imported into the system that already has an existing patient, prescriber, dispenser, and product combination, the system of the present invention has the ability to add only the secondary transaction details instead of adding a duplicate record. This function reduces space and enhances the performance and efficiency of the system.

Referring next to FIG. 7, depicted is a detailed flowchart of Stage 2, illustrated as step 504 of flowchart 500, of the data transformation process of the present invention. Stage 2 takes original transaction records, analyzes them and outputs the results in an Rx_Intervals table. Rx_Intervals is a listing of time intervals which show when event transactions occurred. First, a list of time intervals are built at step 700 from the list of prescription transactions in RX_Transaction table 516 created in Stage 1. Time intervals reduce the amount of data by analyzing the data and recording information representative of the pattern of data rather than the individual transactions. This process identifies all prescriptions for a given product that were purchased by a given patient. The list shows when each transaction occurred.

FIG. 7a is an exemplary diagram illustrating how a time interval is created from transaction information. To create time intervals, transactions are sorted by the variables date_dispensed and refill_no and combined together. New intervals are created whenever there is a break in refill_no sequence. A break in refill_no sequence occurs when the current refill_no is less than the previous refill or there are missing sequential refill numbers.

For example, as shown in FIG. 7a, a patient receives a prescription 744 for ten pills 742 from his physician which the patient purchases on March 1^{st}. The patient is instructed to take two doses per day for five days. As symptoms persist, the patient gets four additional prescription refills from his pharmacy. From the five prescriptions, one time interval 746 is created.

Referring back to FIG. 7, the next step of Stage 2 is to repair missing refill transactions at step 702. Missing refills within a refill_no sequence are treated as present if the projected supply date is consistent with the other known refills. A missing refill 750 within a sequence for one time interval 752 is illustrated in FIG. 7b.

Next, as shown in FIG. 7, the quantity per day prescribed to the patient is calculated at step 704. Per-day dosage data is combined with information on product strength to determine the titration level for the current patient for the time interval at step 706. The end results of the time interval creation process are then stored in RX_Intervals table 520 at step 708. RX_Interval table 520 is linked by rx_id to RX_Master table 514 and each interval contains information on the start date, last refill date, end of refill date, and quantity per day. A chart defining each of the variables contained in RX_Intervals table 520 is depicted in FIG. 7c.

An example of how prescription intervals for a single patient and a single product may look at the end of Stage 2 is shown in FIG. 7d. Diagram 710 in FIG. 7d shows RX_Transaction table entries for the prescription rx_id 469, 814, 736, represented in column 714. Diagram 712 shows the corresponding RX_Interval records for the same prescription rx_id 469, 814, 736 at the completion of Stage 2. The creation of Rx_Intervals significantly reduces the amount of data while still retaining intelligible data. Further, Rx_Intervals may be linked back to previous tables to obtain the detailed records by looking up the rx_ids that match that in the data range from the interval. This allows the system of the present invention to ignore unnecessary transaction details by encapsulating everything in a small identifier.

The data processing warehouse (e.g., the Teradata Data Warehouse) contains an integrated database from which the time intervals are created. The Integrated database consolidates data from 20 different providers and contains information on over 60 percent of drugs dispensed in the United States market. Each time RX_transaction table 514 in the Integrated database is updated, RX_Intervals table 520 must be refreshed.

FIG. 7e is a flowchart of the steps in the algorithm used to update the Integrated database with RX_Intervals. The algorithm uses two macros in this process. First, macro 716 begins by selecting valid records from RX_Transaction table 514 in the Integrated database at step 720. Valid records include record entries that contain both a refill number and a number for the dispensed days supply. The selected transactions are then sorted into “Rx Refill” groups at step 722. “Rx Refill” groups share the same combination of Patient_id, Prescriber_id, NCPDP_nbr and dispensed_NDC9. Each group is identified by its rx_id. Then each rx_id is sorted by dispensed date at step 724. The next step is to calculate derived attributes at step 726 based on the information obtained from the prescription transactions. In this step, RX_Transaction table records are enhanced with calculated attributes that will be needed for creation of RX_Intervals table 520. These calculations include, but are not limited to, the start order of refills, the refills missed, the end date of prescription refills, etc. The algorithm then identifies transactions that start new intervals at step 728. Generally, these are records that start maximal non-overlapping therapy intervals. Next, at step 730, records are filtered in order to exclude records from groups that have unrealistic amounts of transaction per rx_id. In the preferred embodiment, this amount is set to 1095. Thus all groups with more than 1095 transactions are excluded from analysis. Finally, in the preferred embodiment, the results are written to Teradata global temporary table G_Atomic_Intervals table 518 at step 732. The completion of step 732 activates macro 718. This macro begins by grouping records from the global temporary table created at step 732 by rx_id and group_code at step 734. This allows subsequences of transactions for each rx_id to be separated and the results are stored in another temporary table.

For each subsequence, a corresponding interval description record is built at step 736. Records from both temporary tables are joined together on the condition that the rx_id and start_order values match. At step 738, old data is deleted from the Integrated.RX_Intervals table, which is the Teradata Integrated database, updated with the results of RX_Intervals table 520. Finally, at step 740, the new interval descriptions are saved into the Integrated.RX_Intervals table.

Referring next to FIG. 8, shown is a detailed flowchart of Stage 3, illustrated as step 506 in flowchart 500, of the data transformation process of the present invention. Stage 3 begins by taking the calculated time intervals created in Stage 2 and transforming the data into the functional units of Patient and Product at step 800. This allows for easier analysis of prescription events. The results of this “rollup” are stored in Product_Interval table 522 at step 802. Product_Interval table 522 is a temporary table and contains all intervals relating to a patient, product, prescriber, and pharmacy combination. The next step is to roll up all time intervals with related NDC9s into a common Product_ID at step 804. The system of the present invention uses Product_IDs to identify all products sold under the same brand name and MDDB (Master Drug Database) class. MDDB is the preferred embodiment's reference database used to define custom areas and custom classes. This resolves the issue of the same product being sold for two different therapies (e.g., Clarinex is marketed for cold therapy and allergy therapy). The intervals for the product are merged together into one interval. Finally a second temporary table, Tmpg_MergedIntervals table 524, is created at step 806. This table contains new intervals which are the result of consolidation of overlapping intervals. This step again reduces the volume of data. The end result of Stage 3 is a list of products for each patient and the time intervals the patient was taking these products. A chart defining certain common variables contained in Product_Intervals table 522 is shown in FIG. 8a, however, in order to further tailor the analysis additional variables may be utilized. Turning next to FIG. 9, depicted is a detailed flowchart of Stage 4, illustrated as step 508 in flowchart 500, of the data transformation process of the present invention. Stage 4 of the data transformation process begins at step 900 with the evaluation of each entry in Product_Intervals table 522 created in Stage 3. Each entry is evaluated in relation to all other intervals for the same patient. The start_indicator classification for each interval is determined at step 902. Start_indicators show if an interval is the first use of a product, therapeutic category, market, etc. FIG. 9a is an exemplary chart showing five types of start_indicators, which include area start, category start, product start, restart, and intermittent. An area start (indicated by value T) is the first time the patient has taken any product in the therapeutic area. A category start (indicated by value M) is the first time the patient has taken any product in the therapeutic category. A product start (indicated by value B) is the first time the patient has taken the product. Further, a restart (indicated by value R) is when the patient is taking the product after not taking the product anytime in the previous 90 days. Finally, an intermittent (indicated by value X) is when none of the previous conditions are met, indicating intermittent use. Alternatively, other start_indicators may be added to the preferred embodiment to expand analysis.

Continuing with FIG. 9, Stage 4 identifies open intervals at step 904. Open intervals are intervals that are either open on the left (past), right (future) or both. Open intervals occur when there is not enough information either prior to an interval's first transaction or after its last. This may occur when there is a lack of data for a particular pharmacy. The results of Stage 4 are stored in the TEMP_Event_intervals table (FIG. 5b) at step 906. Included in the table are start_indicator flags that indicate the type of start for each interval.

Referring next to FIG. 10 is a detailed flowchart depicting Stage 5 of the data transformation process, illustrated as step 510 in flowchart 500, of the present invention. In Stage 5, each interval in TEMP_Event_Intervals table 526 is evaluated in relation to all the patient's other intervals at step 1000. The interval relations are determined at step 1002. In the preferred embodiment, there are three types of possible relations including Therapy Add-on, Co-Prescribed Therapy and Therapy Switch. The results of this evaluation are stored in Related_Intervals table 528 (FIG. 5b) at step 1004. Start indicators are processed once again at step 1006. This process is repeated to find any therapy starts missed by Stage 4. The results of this analysis are stored in Event_Intervals table 530 (FIG. 5b) at step 1008. Both Event_Intervals table 530 and Related_Intervals table 528 are keyed by patient_id and an interval identifier which is a small incremental number unique to that patient. Once processing of the two tables is complete, they are used to produce statistics on specific markets at step 1010 for market analysis. Finally, the system totals up the number of new starts, switches, etc., at step 1012, based on the two tables. At this point in the data transformation process, the only tables that are relevant are Related_Intervals table 528 and Event_Intervals table 530.

FIG. 10a is a diagram illustrating a more detailed analysis of how related intervals are determined. In this diagram, five exemplary intervals for a given patient are shown. The first interval 1014 represents a therapy start, indicating the first time the patient takes “Product A”. The second interval 1016 indicates a therapy add-on. In this case, “Product B” was added to the patient's therapy regimen in addition to “Product A”. The third interval 1018 represents a therapy switch, in which the patient stops taking “Product A” and begins taking “Product C” which is another product in the same therapeutic area. The fourth and fifth intervals 1020 are classified as co-prescribed therapies since the patient began taking both “Product D” and “Product A” concurrently.

FIGS. 10b-10c provide a more detailed analysis of New Therapy Starts which are events determined in Stage 5 to be new activity for a product in the market. In the preferred embodiment, there are two types of market definitions for analyzing New Therapy Starts which include Therapy Area and Single Class. However, market definitions could be expanded to include additional New Therapy Start categories.

FIG. 10b shows two diagrams illustrating Therapy Area Market Definitions 1030 and Single Class Market Definitions 1032. Therapy Area Market definitions 1030 are used to analyze concurrent switches and other events from one or more products to one or more products. A Therapy Area Market Definition can contain any number of products and classes that a client may desire. Therapy Area Market Definition 1030 shows seven products categorized into two product classes.

Single Class Market definitions 1032 are used to analyze switches, and other events, from one product to another product. A Single Class Market Definition may contain any number of products a client finds practical but only one class. They are also used for building complex, customized Therapy Area Market Definitions. Single Class Market Definition 1032 shows one product class containing seven products.

Referring to FIG. 10c and 10d, diagrams of New Therapy Start Categories grouped into Therapy Area (FIG. 10c) and Single Class (FIG. 10d), identified in the preferred embodiment of the system present invention, are illustrated.

As detailed in FIG. 10c, example 1034 shows the “Switch_to_Mono” function which quantifies the number of patients who stopped taking an existing Therapy Area 1 (TA1) medication regimen and started with another TA1 product. Example 1036 shows the “Switch_to_Co_Prescribed” function which quantifies the number of the patients who replaced an existing Therapy Area 1 medication regimen with two different TA1 products. Example 1038 shows the “Co_Prescribed_Start” function which quantifies the number of the patients who for the first time were concurrently started on two products from Therapy Area 1 (Products A, B, C, D, E, F or G). Next, example 1040 shows the “Co_Prescribed_Add_On” function which quantifies the number of the patients who for the first time ever were concurrently started on two products from Therapy Area 1 (Products A, B, C, D, E, F or G) while on an existing drug regimen. Example 1042 shows the “Add_On” function which quantifies the number of patients who for the first time were started on one product from Therapy Area 1 (Products A, B, C, D, E, F or G) while on an existing TA1 medication regimen. Diagram 1044 shows the “Category_Start” function which quantifies the number of the patients who for the first time ever used any product in Product Class 1 (Products A, B, C or D). Example 1046 illustrates the “Area_Start” function which quantifies the number of the patients who for the first time ever used any product in Therapy Area 1 (Products A, B, C, D, E, F or G). Next, example 1048 illustrates the “Brand_Restart” function which quantifies the number of the patients who had once taken Product A and were restarting use of the product after 90 days or more. Example 1050 shows the “Category_Restart” function which quantifies the number of the patients who had once taken Product C and were starting use of another product in the class (Product A) after 90 days or more.

As detailed in FIG. 10c, example 1052 shows the “Switch_To” function which quantifies the number of the patients who ceased taking an existing Product Class 1 medication regimen and started with another PC1 product. Example 1054 illustrates the “Therapy_Start” function which quantifies the number of the patients who for the first time were started on any product from Product Class 1 (Products A, H, I, J, K, L or M). Next, example 1056 shows the “Brand_Restart” function which quantifies the number of the patients who had once taken Product A and were restarting use of the product after 90 days or more. Finally, example 1058 shows the “Therapy_Restart” function which quantifies the number of patients who had once taken Product K and were starting use of a different Product Class 1 product (A) after 90 days or more. The number of days can be varied for each of the functions. In the preferred embodiment, the number is set to 90 days.

While, the above stages have been described with respect to the detection of specific therapy events, additional event detection methods may be incorporated into the system of the present invention. For example, the system may be designed to detect therapy events related to dosage titration. In this case, the physician prescribed dosages may be monitored and tracked providing information on doctor behavior and patient management. The algorithm for this type of analysis may incorporate statistical processes to determine dosage levels.

Another possible analysis is the order of therapy detection which involves treatment patterns that physicians engage in. For example, a physician may start with the same type of drug to treat an illness and follow a similar pattern of drug additions or switches for each case. This study provides an identification of physician practices of medicine in general. The analysis may rely on Markov chain analysis in order to express the probability of therapy changes.

A further type of event detection may involve identifying influence networks. This includes analysis of who makes decisions for a patient, what type of physicians (e.g., general practitioner, specialist, etc.) make certain decisions regarding patient therapy. This method of linking may be used to show referral patterns across different therapy areas.

Referring next to FIG. 11, depicted is a flowchart detailing the last stage, Stage 6 illustrated as step 512 in flowchart 500, of the data transformation process of the present invention. This stage produces completed market studies and begins by filtering the information contained in Event_Intervals table 528 and Related_Intervals table 530 at step 1100. Next, prescription events are created for a given product or market at step 1102. The final study tables are then converted to Single Product Class or Therapy Area market studies, based on client specifications at step 1104. The output is eventually published to client portals at step 1106 in the form of application study documents where they are ready for use by the client.

The system of the present invention includes a number of steps that make prescription data transformations a clean and safe process. For example “shadow tables” are used to safeguard against update loading problems and allow administrators to restore records if a problem occurs.

In the preferred embodiment of the present invention, the data transformation process relies on various data sources as look-up tables. These data sources need to be updated with the latest available information. The system can contain any number of reference databases as needed for different markets. Referring to FIG. 12, a detailed flowchart 1200 is shown illustrating the process for updating the system's Master Drug Database. The system uses a Master Drug Database (MDDB) as a reference database to define custom areas and custom classes with a list of IDs. First, at step 1202, MDDB updates are retrieved in the form of a CD-ROM transaction file. MDDB master record tables are updated with the MDDB file at step 1204. The update process performs the appropriate extraction steps automatically and updates the key tables. Next, all auxiliary files are updated at step 1206. Auxiliary files are look-up tables that need to be updated whenever there is new data available. At step 1208, the newly updated tables are transformed to build drug tables used by the system of the present invention in the data transformation process. This task builds the product name ID table, allocates product name IDs and includes an algorithm which determines what a product name is as well as an ID look-up. Since the update process is staged on the SQL server, the results of the process must be integrated with relevant data from the external MDDB reference database at step 1210 and loaded into the data processing environment.

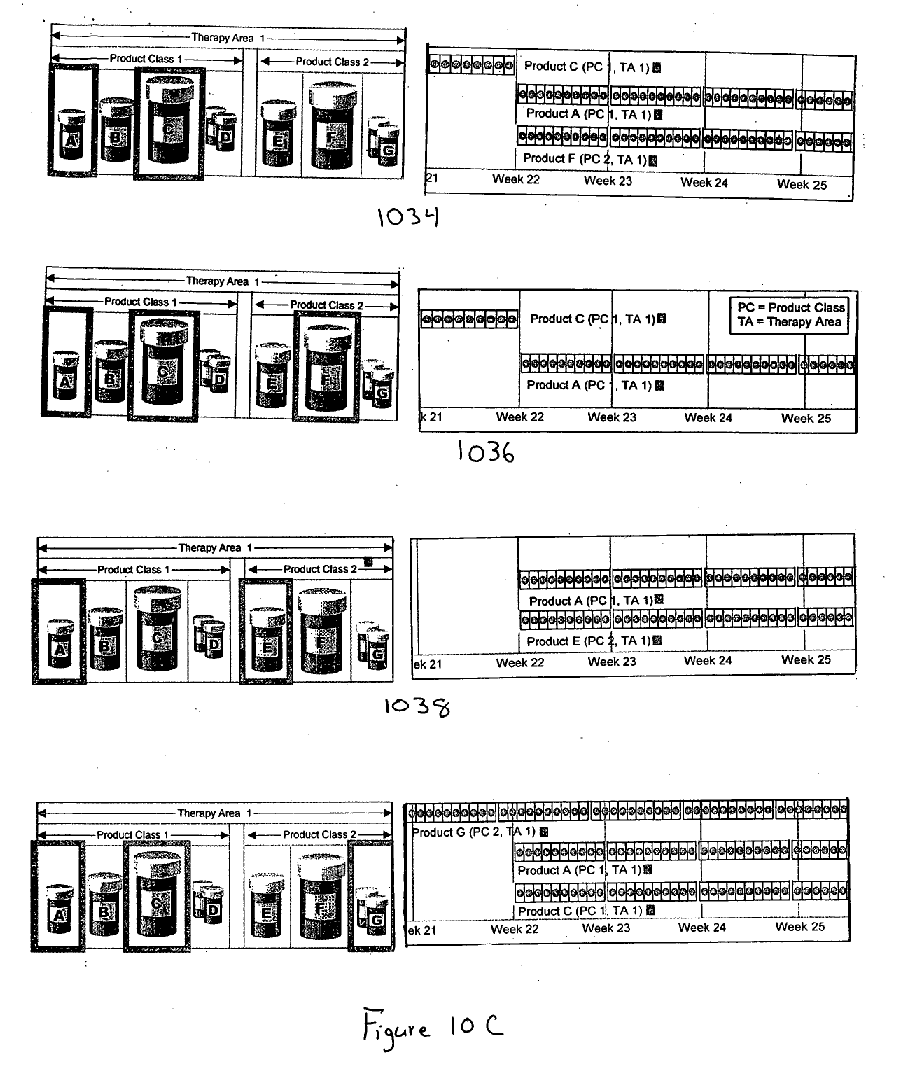

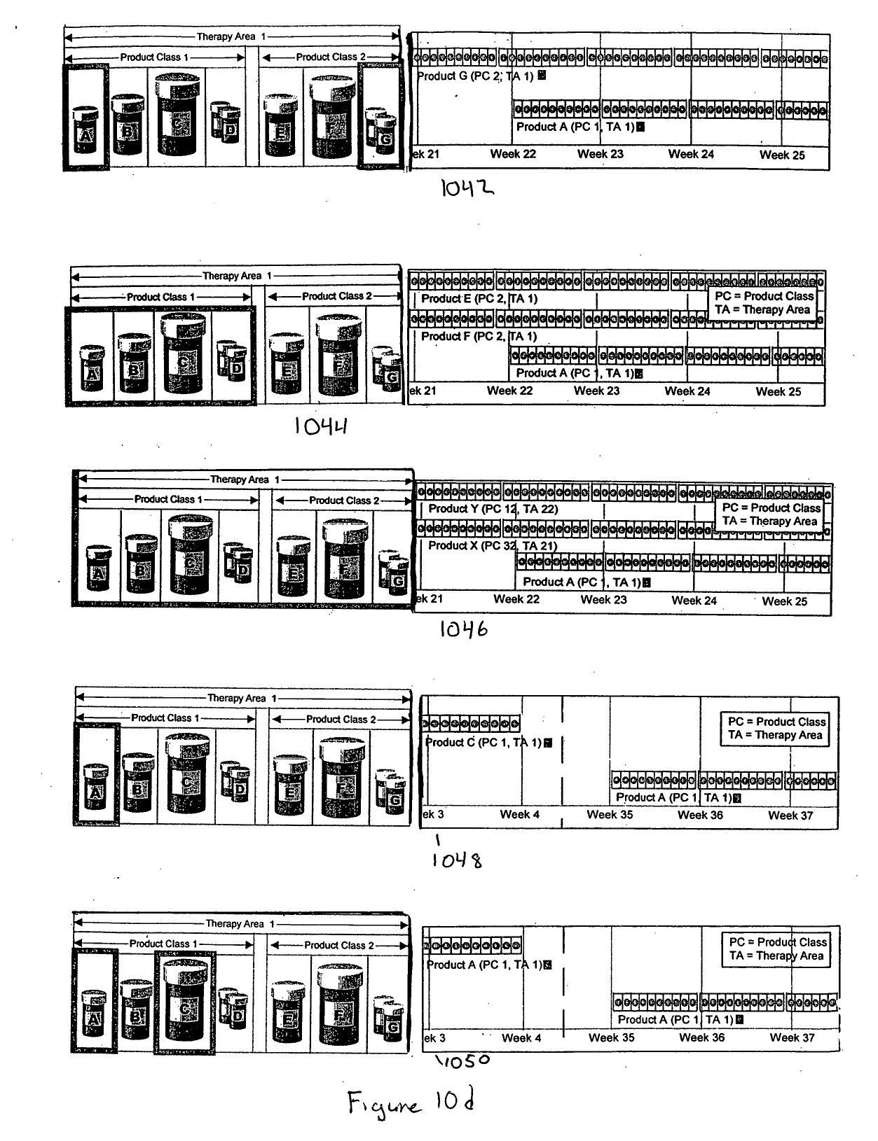

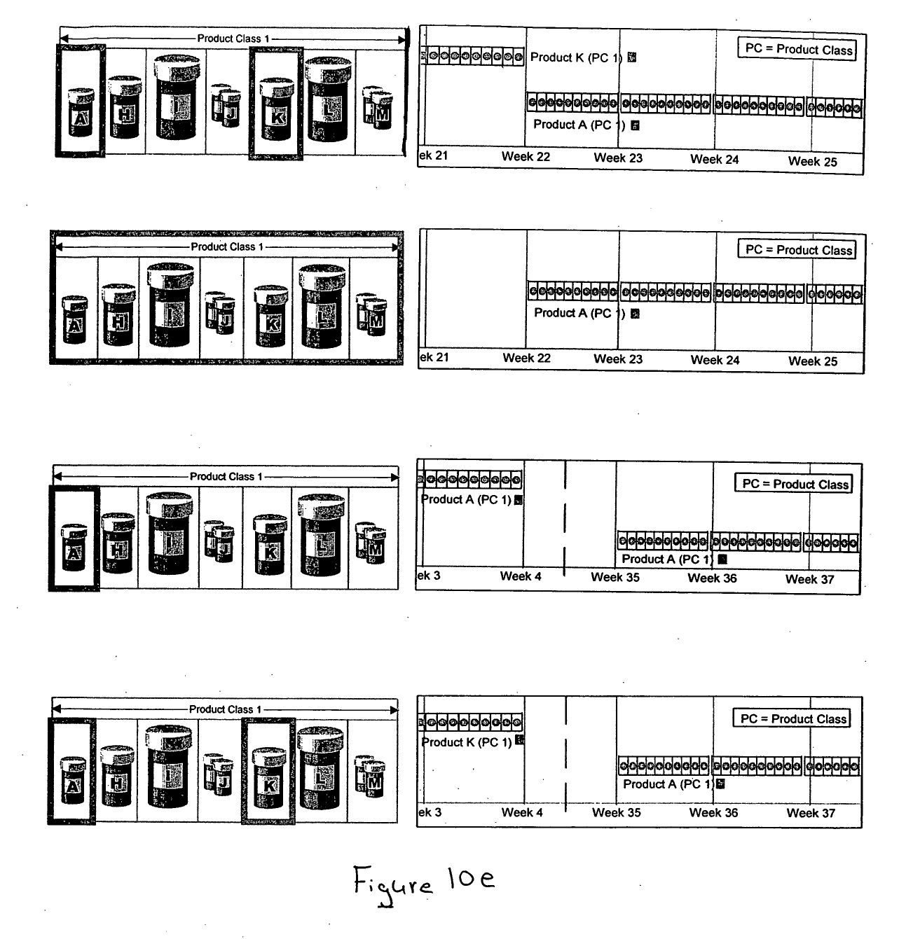

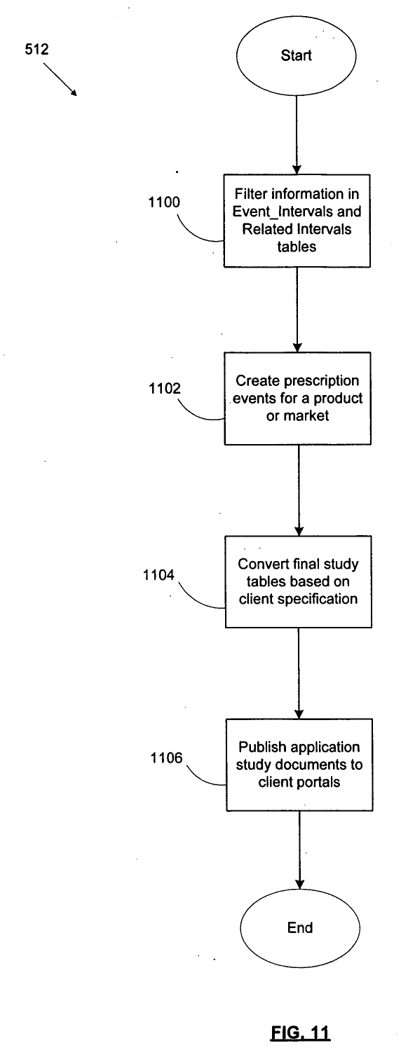

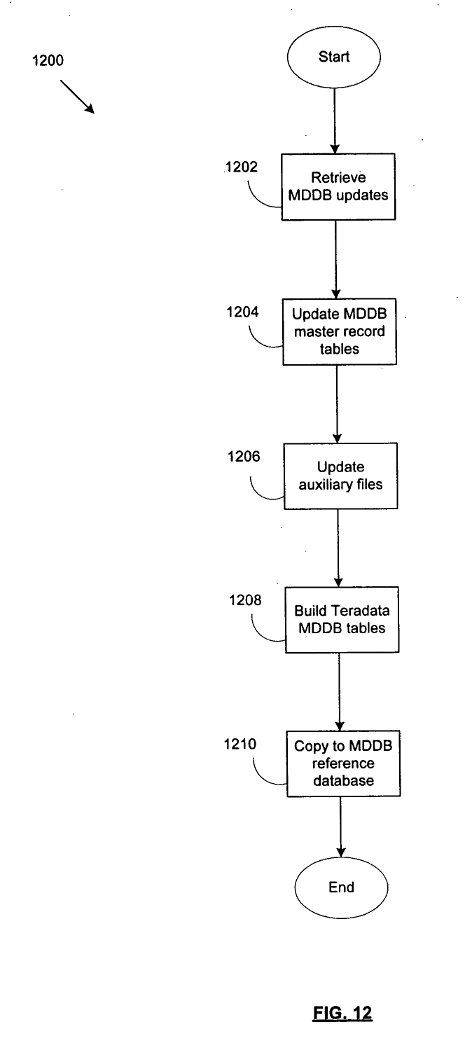

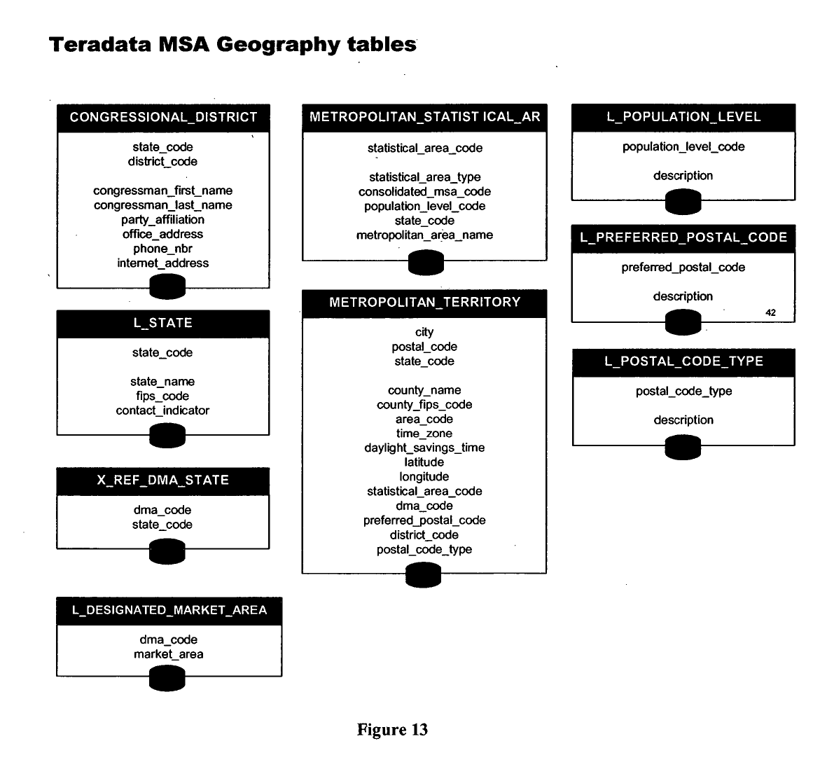

The system of the present invention contains additional source look-up tables for Metropolitan Statistical Area (MSA) data that must be updated with the latest data in order to perform data transformation processes. Exemplary MSA source look-up tables for the preferred embodiment of the present invention can be seen in FIG. 13. The process for updating MSA tables loads data from flat files residing on the same server, into the different MSA database tables used as look-up tables in the data transformation process.

Once data transformation processes are complete, the tables containing all of the data transformation process results, external data and database information used as source look-ups including prescriber and dispenser data, drug tables, geography data, etc. are loaded into the database management environment. External databases include, for example, physician (i.e., prescriber) data and geo-demographic data. This data is used as the source for a variety of details on registered physicians in the US market. This data includes but is not limited to address, medical specialties, etc. Demographic data is provided by the US Census. The data is loaded directly into database tables using SQL commands.

In the database management environment, event files are created from the event tables formed in the data transformation process integrated with market definition data for each client already stored in the database management environment. The system executes extraction queries to create output files for Therapy Area and Single Class markets from the created event files. The results produce 4 output files per Therapy Area market and 2 output files per Single Class market. The collection of client specifications and the creation of market definitions is depicted and discussed in further detail with respect to FIG. 16.

Referring now to FIG. 15, shown is a detailed flowchart illustrating the steps of the system's Extraction, Transformation and Loading (ETL) Service for data summarization of the preferred embodiment of the present invention. The data obtained through data transformation calculations is combined with client market definitions in the data summarization process. This process creates summarized market views for specific clients. Data is extracted from the study files created in the data transformation process in order to create individual market views. The ETL Engine executes scripts for each task involved in the data summarization process.

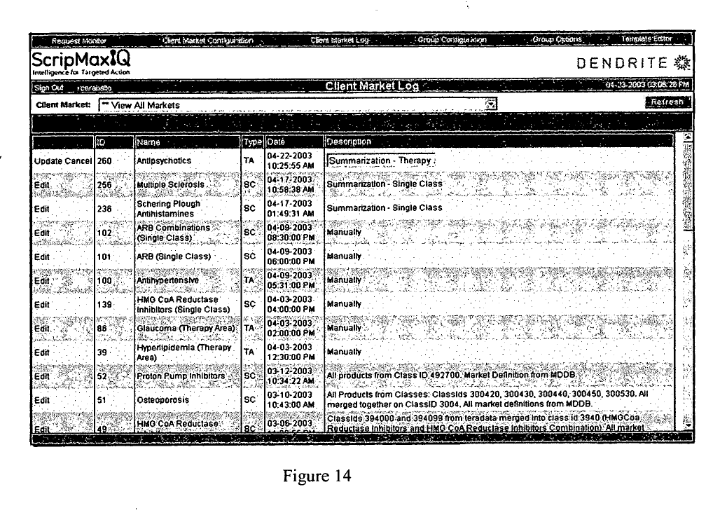

Referring to flowchart 1500 in FIG. 15, study files are first retrieved from the data processing warehouse at step 1502. Next, the retrieved files are loaded into the system's database management environment at step 1504. The summarization process begins with the creation of summarization tables at step 1506. At this point, all old data tables for the selected market are erased and the market definition becomes unavailable to clients. Next, all other tables needed to create views and reports are created at step 1508. The summarization status may be checked at step 1510 via a Client Market Log. An exemplary Client Market Log is illustrated in FIG. 14. Finally, the resulting summarized data is stored in database tables as summarized views at step 1512.

Referring next to FIG. 16, shown is a detailed flow chart illustrating the steps for creating market definitions based on client requirements in the preferred embodiment of the present invention. Client definitions can be created for new clients and already existing clients. The first step, as shown with reference to FIG. 16, is to collect client requirements and determine client's market analysis needs at step 1602. Clients are able to analyze data at national, state, MSA levels, doctor or sales territory levels, etc. Next, research is performed to determine whether an existing study or new study would best meet the client's needs at step 1604. It must be confirmed whether products already exist in the database, and which existing studies may be applicable to the client's needs. Studies may be used more than once for different clients. At step 1606, a new market definition is created or an existing market definition is updated based on client requirements. In the preferred embodiment, the market study is prepared using a visualization tool as well as data provided from Fact and Dimensions MDDB database which provides raw data information. For each market, the client must specify a study type preference, either Therapy Area or Single Class. When a new market is created, details on the market study must be input to the system using a visualization tool. Next, market definitions are analyzed for feasibility at step 1608 to determine whether the proposed specifications meet the client's needs. The proposed definitions are then sent to the client for finalization at step 1610. An initial prototype study is run at step 1612 based on the client-approved market definition and presented to the client. Following client review and approval, the new market definition becomes available to the client to create studies at step 1614 through their existing Web portal. When new market definitions are created, drug tables must be updated with new client markets, or any other look-up tables which rely on market definitions.

A client can update, change, or create a new market study. A closer look at using the system to analyze markets from the user's perspective is depicted and discussed with respect to FIG. 18.

The Web environment of the system software architecture delivers the summarized client views stored in the database tables to the user's Web browser. Configuration of web browser options, user options, settings and system specifications is performed using a Web-based administration portal. Also on the Service administration Web site, service for clients with shared server requirements or dedicated server requirements is established. Referring next to FIG. 17, a detailed flowchart of the administration of day-to-day system study requests using the administration module of the preferred embodiment of the present invention is shown. First, the administrator may log onto the system administration site via the administration portal at step 1702. Depending upon client activity, there may be a list of pending jobs or new report requests that require attention at step 1704. In the preferred embodiment, a request monitor is used to manage and monitor incoming report requests. Pending reports are monitored at step 1706. Pending report requests are reports waiting to be processed. This step involves checking the scheduled run date, troubleshooting, and looking for problems in the processing queue. Next, finished reports must be reviewed and verified with client selected options at step 1708. Problems may occur which require three different actions. In case of a problem with the original job specifications from the client, the specifications are reviewed and adjusted and the job is reprocessed and reloaded at step 1716. If the system's data warehouse was undergoing its scheduled refresh process when the report was submitted, the job must be re-run at step 1716. Files that cannot be processed or transferred to the client's Web portal are rejected at step 1714. An error notice is sent at step 1720 and stored in an error queue. Re-processed reports go back to step 1708 for review. Successful reports are approved at step 1710 and sent to the client for review at step 1712.

Referring next to FIG. 18, a detailed flowchart illustrating the use of the system to analyze markets from the user's perspective is shown. At step 1802, the client user logs in to the system via the client Web portal. The client may be asked to enter a username and password for security purposes. Once logged into the system, the client assesses the market overview and alerts at step 1804. Alerts may notify the client of completed reports, requests, or any other important information. Next, the client reviews the overview report at step 1806. This report indicates the areas of interest. The client can either view a completed market study report, if available, or configure a new personal market view at step 1808. The client must define the specifications and details necessary for creating market definitions. This includes giving the view a descriptive name, selecting products/categories to be studied, defining study dates, and specifying the geographic area. At step 1810, the client releases the view specifications for production. System administrators work with the specifications to create market definitions and market study reports. The client must allow 48 hours (step 1812) to view completed reports.

If a completed market study report is available, the client can work with the market view at step 1814 to prove or disprove market assumptions, discover unexpected trends, and arrive at fact-based conclusions. The completed market view reports are published as application documents with various analysis views in the form of tables, charts and geographic maps. These view elements may be output to produce reports for further analysis at step 1816.

The system provides a Template editor to set up file templates used to graphically display study data to clients on the user interface. The Template editor is used for adding, naming and activating new templates for the system. Referring to FIG. 19, shown is a detailed flowchart illustrating the steps for setting up file templates for a client in the preferred embodiment of the present invention. All available templates are stored in a master folder. This folder is first accessed at step 1902 and the particular templates are selected based on input from the client. For example, specifications may call for a therapy area, single class template, etc. The files must be copied and their file names customized at step 1904. Next, the file publisher application is used to open the application file at step 1906 to customize the file. The template's settings panel must be opened at step 1908 and then parameters are entered at step 1910. This includes client name, client's access serial number, application name, etc. The access serial number acts as a security feature to ensure that studies can be viewed only by those for whom they were intended. Each client is assigned a unique application name and serial number which acts as a password. Using this feature, one client cannot view data from other client's application files. In the preferred embodiment, serial numbers are kept in the same folder as the master templates. Any future templates created for the same client will share the same serial number. The new file is saved as a text file at step 1912. The last script line must be removed each time a template file is edited at step 1914. This line is automatically added every time a template file is opened and uses the path of the current computer to reference its files and could generate errors when the template is moved to another computer. The correct reference line is added each time the system's Summarization Engine opens and uses the template file to create study documents. The template file is saved and the blank template is then edited at step 1916. This includes adding a description of the template, display name, height and width display size, and template type (e.g., Single Class or Therapy Area). The data is saved to the server and ready to be linked to the correct user group/portal at step 1918.

In the preferred embodiment of the system of the present invention, each client group has access to its own customized Website and Web portal. The system contains a Group Configuration editor to create client groups and define the options for each group. Also, groups can be deactivated and reactivated using the Group Configuration editor. Once a new group is created, the settings must be customized to client requirements. These settings include, but are not limited to, approval required flag, default processing priority, file application delay, user notification, page, user notification server, etc.

Referring next to FIGS. 20a-20l, depicted are exemplary analysis views of the system's user interface of the preferred embodiment of the present invention. The applet is designed with features that include drop down selection boxes, dynamic and selectable charts allowing users to interactively explore the market, a correspondent table for every chart, share percentage calculations relative to the products defined in the client's custom market definition, and maximization of charts and tables for better viewing. FIG. 15a compares the two types of views that users can use to analyze a market. Therapy area market views are used to analyze events from one or more products to one or more products such as concomitant switch, add-on, co prescribed, etc. Single class market views are used to analyze events from one product to another product including switches. Single class market definitions contain only one product class.

FIG. 20b depicts the number of events of Brand Starts (New Therapy Starts) across products and prescription types. In addition, depicted is the number of shares of Brand Starts.

FIG. 20c depicts a sales trend over the course of several months for the selected products. The chart can be alternated between “Number of Events Mode” which tracks the absolute number of Brand Starts and “Share Mode” which displays the relative share trends for the selected products.

FIG. 20d depicts events by state which can be selected to show the absolute number of events and the relative number of events. This analysis can be displayed as a map in which states are ranked according to product activity. The darker colors indicate greater activity.

FIG. 20e depicts a national list of Metropolitan Statistical Areas (MSAs). In addition, corresponding maps are depicted.

FIG. 20f illustrates how switches are displayed. The middle tab shows switches from a combination of one or more co-prescribed products to another combination of one or more products. The lower chart displays net growth/decrease for products.

FIG. 20g depicts “Switch To” and “Switch From” trends along with the “Share” chart which shows the share of the defined market that is either switching to or from a given product or product combination.

FIG. 20h depicts two charts with trends for selected products and product combinations, one “From” and the other “To” the selected item. The charts can display either market share or event totals.

FIG. 20i illustrates two charts showing switches for state and MSA.

FIG. 20j depicts charts and tables for co-prescribed events used to study combinations of products that were prescribed at the same time.

FIG. 20k depicts charts and tables for Add-on events used to analyze products that were added on to an existing combination of products being prescribed to a patient. The “Share” chart shows the number of prescriptions for each group of products and the “Number of Events” chart shows the absolute number of events for each group of products.

FIG. 20l depicts the tabs used to configure the state and MSA maps displayed by “Map It” buttons. In automatic mode, map details, such as water and county boundaries, city markers, etc., appear on maps automatically. In custom mode, users select exactly which layers or labels to hide or display.

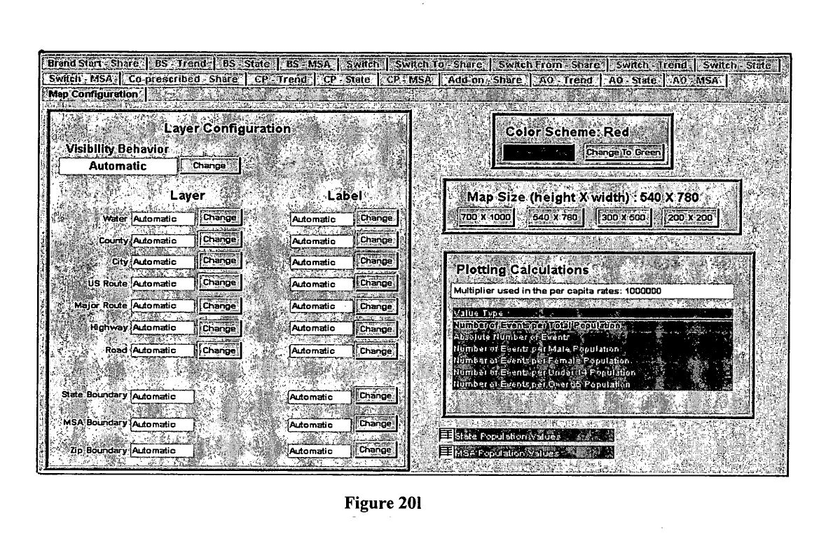

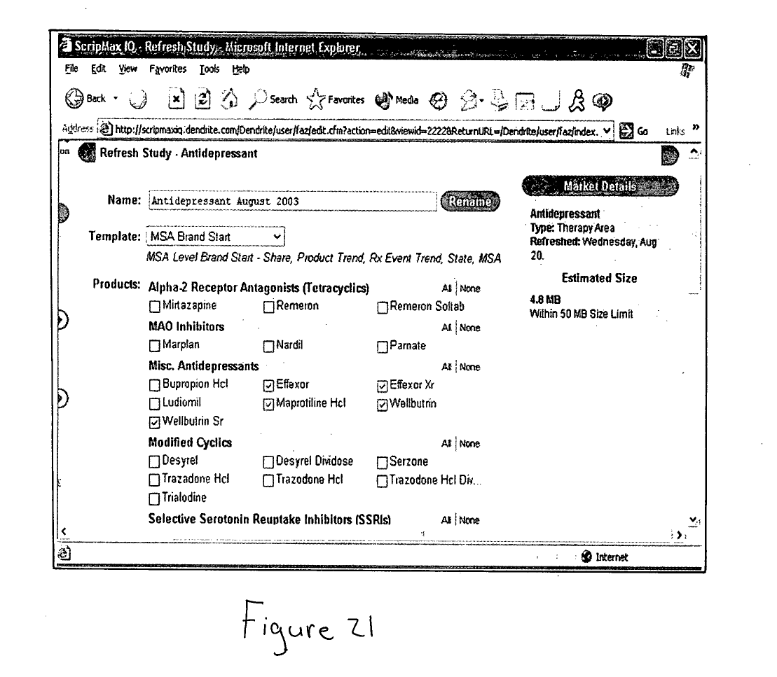

FIG. 21 depicts an exemplary study request entered on a user's web portal for a study on antidepressants. The user selects from a menu of choices for type of study. In this particular case, the study is an MSA Brand Start study. Products from different categories are chosen to create a therapy area study. In the preferred embodiment, the products are selected by checking the boxes next to the product name under each class. Any number of products from any number of classes may be selected.

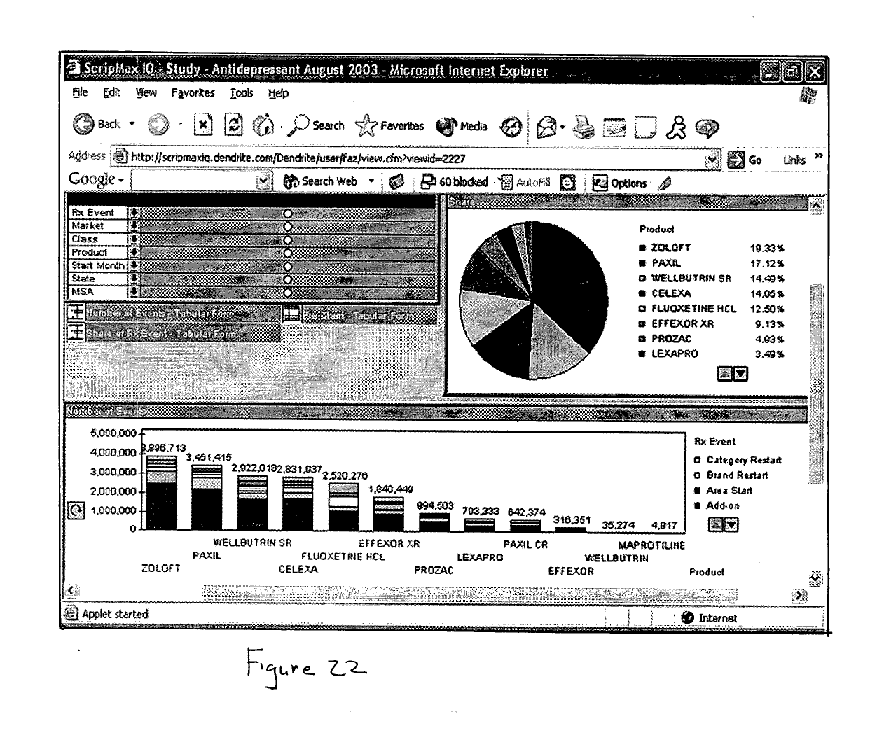

FIG. 22 illustrates a result analysis for the exemplary antidepressant study specified in FIG. 21. The pie chart of FIG. 21 shows the brand start share of each selected product in the market. The bar graph chart shows the number of events that occurred for each type of prescription event for each selected product.

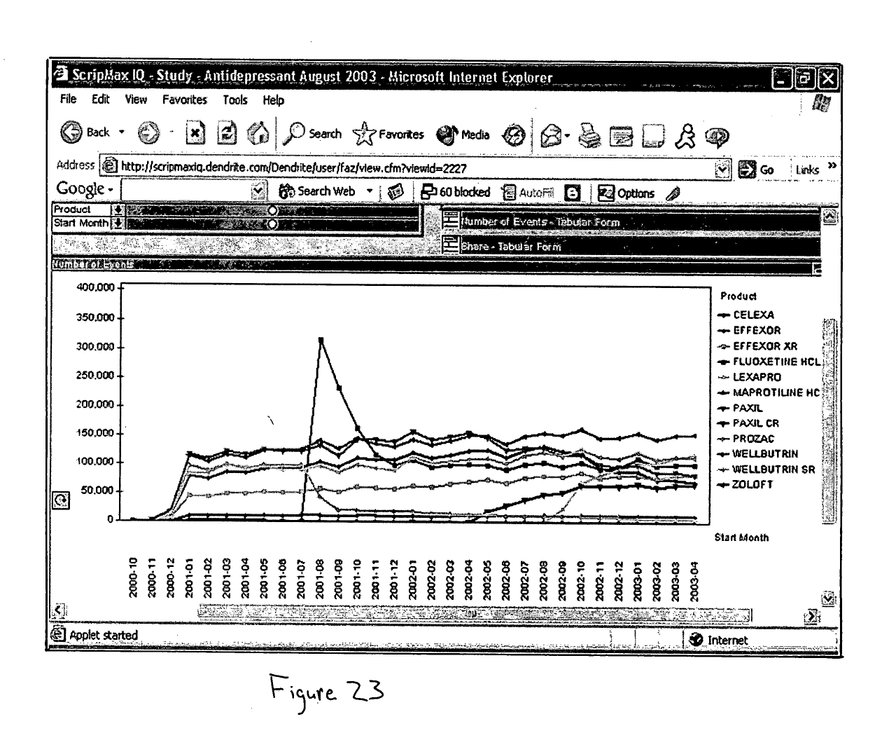

FIG. 23 illustrates another result analysis for the exemplary antidepressant study specified in FIG. 21. This chart depicts the number of events that occurred for each product over a period of time. This allows the user to study and compare the trends among the products to determine any product relationships.

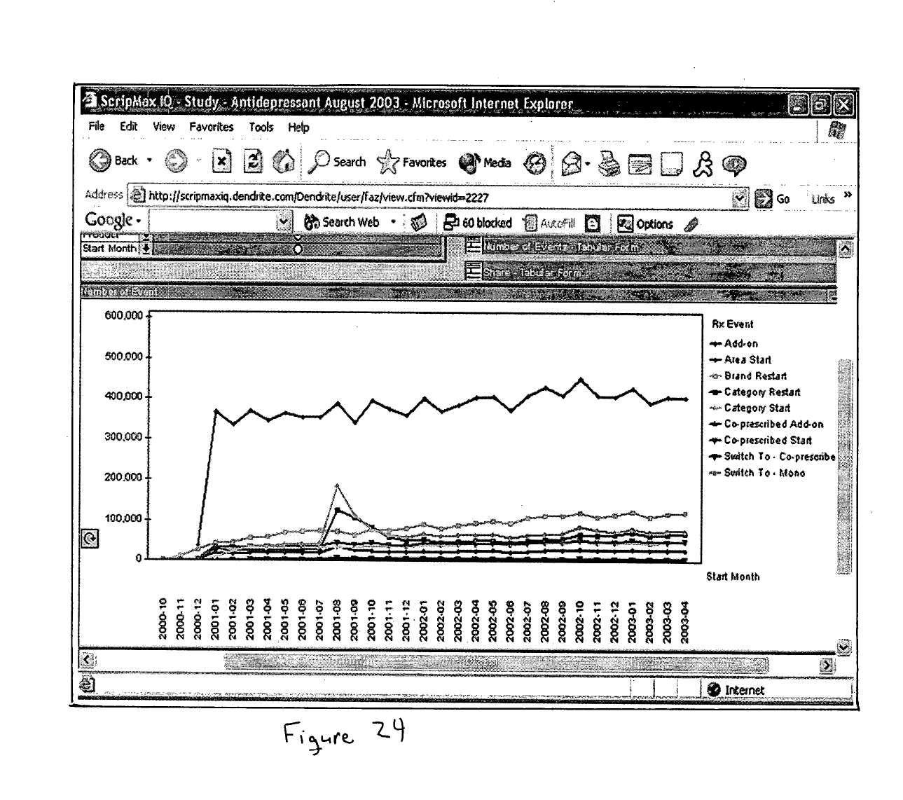

FIG. 24 depicts another result analysis for the exemplary antidepressant study specified in FIG. 21. This chart displays the number of events for each type of event for all products together over a period of time. This allows the user to study event trends and compare results based on the type of event for all products combined.

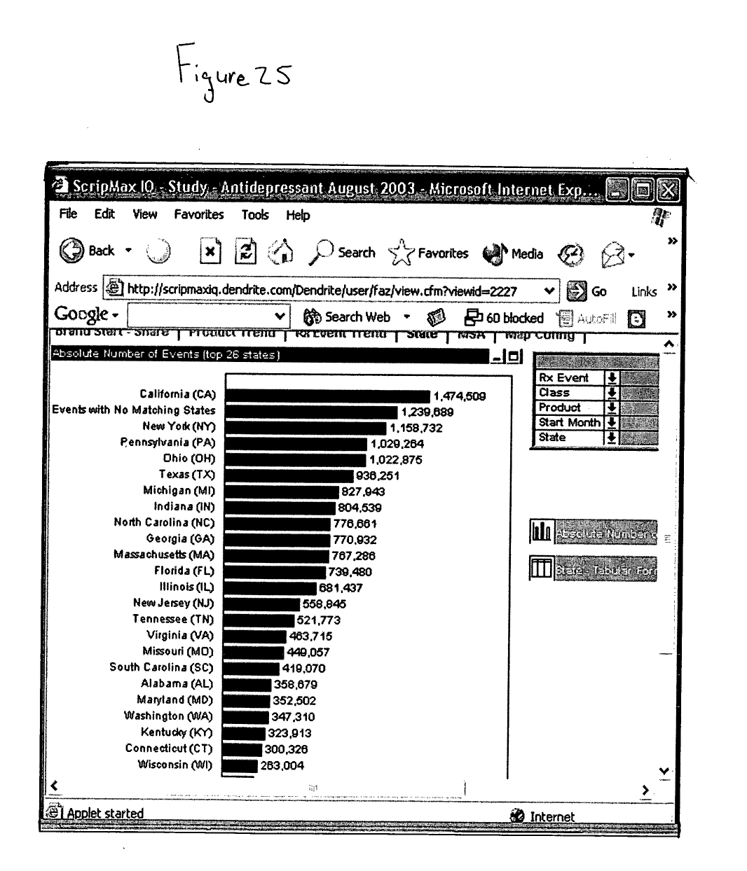

FIG. 25 depicts another result analysis for the exemplary antidepressant study specified in FIG. 21. This chart shows the absolute number of events occurring in each state. Similarly, the absolute number of events occurring in each Metropolitan Statistical Area may be displayed.

In the preferred embodiment, the client has a number of options for viewing the charts and graphs. For example, the client can specify the size, color scheme and plotting calculations for each analysis. Further, the client has the option of sharing the study with other users of the system, or editing the study to create a new one.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. A method for transforming raw transactional data comprising the steps of:
accessing said data via a communication network from at least one external source;
formatting said data, wherein said formatting includes cleaning and validating said data;
longitudinally linking said data;
compressing said data;
storing said data in at least one database;
extracting said data from said at least one database for analysis; and
displaying results of said analysis.

2. A method for transforming raw transactional data according to claim 1, further comprising the step of creating interval interpretations of data representing activity over time.

3. A method for transforming raw transactional data according to claim 1, wherein said data is pharmaceutical transactional data.

4. A method for transforming raw transactional data according to claim 1, wherein said communication network is selected from the group consisting of an internet, an intranet, a wireless network, a cellular network, a wide area network, a local area network, a virtual private network, a token ring network, and a dial-up network.

5. A method for transforming raw transactional data according to claim 1, wherein said compressing comprises the steps of:
(a) inserting said data into storage tables;
(b) sorting and evaluating said data;
(c) performing calculations on said data; and
(d) creating interval tables of said data.

6. A method for transforming raw transactional data according to claim 1, wherein said analysis is performed based on end-user specifications.

7. A method for transforming raw transactional data according to claim 1, wherein said analysis is used for market studies.

8. A method for transforming raw transactional data according to claim 7, wherein said market studies comprise Therapy Area and Single Class.

9. A method for transforming raw transactional data according to claim 1, wherein said compressing retains all information represented by said raw transactional data.

10. A method for transforming raw transactional data according to claim 1, wherein said analysis includes data summarization.

11. A method for transforming raw transactional data according to claim 1, wherein said results are delivered to an end-user via a communication network.

12. A method for transforming raw transactional data according to claim 1, wherein said data and said results are continuously updated over an extended period of time.

13. A method for transforming raw transactional data according to claim 1, wherein said analysis includes data summarization.

14. A method for transforming raw transactional data according to claim 1, wherein said transactional data remains anonymous.

15. An apparatus for transforming raw transactional data comprising:
at least one communication network for transfer of said data;
a data extraction, transformation and loading tool;
at least one database for storage of said data;
at least one data processor for processing and compressing said data;
a plurality of system applications for running scripts, wherein said scripts perform data analysis, extraction, transformation and loading; and
a web browser for displaying results of said data analysis.

16. An apparatus for transforming raw transactional data according to claim 15, wherein said communication network comprises at least one communication device, a plurality of data gathering devices, at least one communication link, and at least one network protocol.

17. An apparatus for transforming raw transactional data according to claim 15, further comprising a geo-mapping environment for backup storage.

18. An apparatus for transforming raw transactional data according to claim 15, wherein said displayed results are in the form of applets.

19. An apparatus for transforming raw transactional data according to claim 15, wherein said displayed results are used for market studies.

20. A method for compressing data comprising the steps of:
accessing raw data from at least one external source;
formatting said raw data, wherein said formatting includes cleaning and validating;
storing said raw data into tables;
creating intervals from said raw data and storing said results into tables; and
extracting market studies from said results for analysis.

21. A method for compressing data according to claim 20, wherein said data is continuously updated over a period of time.
